(19) United States
(12) Patent Application Publication
(10) Pub. No.: US 2013/0235323 A1
(43) Pub. Date: Sep. 12, 2013

(54) ELECTROCHROMIC DEVICES PREPARED FROM THE IN SITU FORMATION OF CONJUGATED POLYMERS

(71) Applicants: Gregory Allen Sotzing, Storrs, CT (US); Michael Anthony Invernale, West Haven, CT (US); Yujie Ding, Naugatuck, CT (US)

(72) Inventors: Gregory Allen Sotzing, Storrs, CT (US); Michael Anthony Invernale, West Haven, CT (US); Yujie Ding, Naugatuck, CT (US)

(21) Appl. No.: 13/606,829

(22) Filed: Sep. 7, 2012

Related U.S. Application Data
(60) Provisional application No. 61/532,890, filed on Sep. 9, 2011.

(51) Int. Cl. B01J 19/08; G02C 7/10; G02F 1/15

(52) U.S. Cl. CPC B01J 19/087; G02F 1/1523; G02C 7/101
USPC 351/44; 359/265; 204/165

(57) ABSTRACT

Disclosed herein are electrochromic devices, including eyewear, windows, and displays, prepared by in situ formation of conjugated polymers.

### CROSS-REFERENCE TO RELATED APPLICATIONS

This application claims the benefit of U.S. Provisional Application Ser. No. 61/532,890, filed Sep. 9, 2011, which is incorporated herein by reference in its entirety.

### TECHNICAL FIELD

The present invention is in the field of electrochromic devices, and more specifically, in the field of electrochromic devices utilizing a conjugated polymer formed inside or outside an assembled solid-state device.

### BACKGROUND

Variable light transmission has been a goal of the eyewear and window industries for many years. However, a cost-effective technology with the right feature characteristics has not yet emerged.

Photochromic tinted sunglasses and windows have been common for some time. While these products have become popular in some segments of the eyewear market, their slow switching speed, lack of color choice, and high cost have slowed their overall adoption.

Liquid Crystal Displays (LCD) are sometimes used as tinted windows for face masks (welding masks) and have been demonstrated in visor type applications. However, these solutions are heavy, rigid, and costly. Their lack of flexibility/support for curved surfaces, and power requirements have made them ineffective for broad based applications.

Suspended particle displays (SPD) are often used for privacy glass, but have not been effectively used for eyewear or other applications.

Light emitting diodes (LED) are often used for display applications, but have not been effectively used for eyewear or other applications.

An electrochromic device is a self-contained, two-electrode (or more) electrolytic cell that includes an electrolyte and one or more electrochromic materials. Electrochromic materials can be organic or inorganic, and reversibly change visible color when oxidized or reduced in response to an applied electrical potential. Electrochromic devices are therefore constructed so as to modulate incident electromagnetic radiation via transmission, absorption, or reflection of the light upon the application of an electric field across the electrodes. The electrodes and electrochromic materials used in the devices are dependent on the type of device, i.e., absorptive/transmissive or absorptive/reflective.

Absorptive/transmissive electrochromic devices typically operate by reversibly switching the electrochromic materials between colored and bleached (colorless) states. Typical electrochromic materials used in these devices include indium-doped tin oxide (ITO), fluorine-doped tin oxide (SnO₂:F), poly(3,4-ethylenedioxythiophene)-poly(styrene sulfonate) (PEDOT-PSS), and single-walled carbon nanotubes (SWNT). An exemplary electrochromic device of this type has been constructed using a substrate layer of polyethylene terephthalate (PET), a transparent layer of ITO as the working electrode, the electrochromic layer (included within the gel electrolyte matrix) and another transparent layer of ITO as the working electrode atop the substrate layer of polyethylene terephthalate (PET).

The absorptive/reflective-type electrochromic devices typically contain a reflective metal as an electrode. The electrochromic material is deposited onto this electrode and is faced outward to allow incident light to reflect off the electrochromic material/electrode surface. The counter electrode is behind the active electrode. Similar electrode and electrochromic materials can be used in these reflective devices, in particular ITO and PEDOT-PSS.

Traditionally built electrochromic devices utilizing an electrochromic polymer have a discrete electrochromic polymer layer assembled with an electrolyte on top. Devices are assembled between two electrodes using the electrolyte between them to achieve the necessary ion shuttling for the redox-active electrochromic polymers. This electrolyte is often cross-linked into a gel.

In traditional processes to prepare the foregoing electrochromic devices using an electrochromic polymer such as PEDOT, the electrochromic polymer is formed into a discrete thin film prior to device assembly. Typical processes to prepare the thin film are via electrodeposition, spin or spray casting from solutions, etc. Drawbacks to using electrodeposition include the use of costly and wasteful electrolyte baths, the need for the frequent changing of organic salts and solvents in the baths, as well as the need for proper disposal of spent baths. Electrodeposition processes are also known to have poor yields.

Other processes besides electrodeposition involve complex syntheses to generate soluble versions of an electrochromic polymer which can then be cast and assembled into a device. The use of so-called precursor polymers can be used in a casting process and then converted to their electrochromic counterpart. However, such a process still involved the initial preparation of an electrochromic polymer film prior to device assembly.

There remains a need in the art for electrochromic devices such as eyewear, windows, and displays that can be assembled simply, inexpensively, and with less waste than traditional processes. There also remains a need for electrochromic devices having improved properties.

### BRIEF SUMMARY

In one embodiment, a method of forming a solid-state device comprises filling a gel electrolyte precursor and an electroactive precursor into an enclosed chamber, wherein the electroactive precursor is an electroactive monomer, a conducting oligomer, a viologen, a conducting polymer precursor, or a combination thereof; crosslinking the gel electrolyte precursor to form a combination of a crosslinked gel electrolyte composition comprising the electroactive precursor, wherein the combination is disposed between at least two electrodes, and wherein a potential source is in electrical communication with the at least two electrodes; and applying a voltage to polymerize the electroactive precursor to form a composite comprising conjugated polymer and crosslinked gel electrolyte composition.

In another embodiment, an electrochromic eyewear device comprises at least two electrodes; and a composite disposed between the at least two electrodes, the composite comprising a conjugated polymer and a crosslinked gel electrolyte composition; wherein the composite is formed by in situ polymerization of an electroactive precursor in a combination comprising the crosslinked gel electrolyte composition and an electroactive precursor, wherein the electroactive precursor is an electroactive monomer, a conducting oligomer, a viologen, a conducting polymer precursor, or a combination thereof; and wherein the conjugated polymer is not formed as a discrete film.

### BRIEF DESCRIPTION OF THE DRAWINGS

The components in the drawings are not necessarily to scale, emphasis instead being placed upon clearly illustrating the principles of the embodiments described herein. Moreover, in the drawings, like reference numerals designate corresponding parts throughout the several views.

FIG. 1a is a schematic of a procedure for the in situ polymerization of an electroactive precursor (a monomer in this example) into a conjugated, conducting, electrochromic polymer inside an assembled solid-state device.

FIG. 1b is a schematic of a procedure for the in situ polymerization of an electroactive precursor (a monomer in this example) into a conjugated, conducting, electrochromic polymer inside an assembled, three electrode solid-state device.

FIG. 2 illustrates a general schematic of a coated lens for an electrochromic eyewear device.

FIG. 3 is an image of an exemplary assembled ballistic goggle electrochromic device in its oxidized (A, clear/yellow) and neutral (B, dark/blue) states.

FIG. 4 is an exemplary schematic layout of a prototypical goggle-type electrochromic device architecture.

FIG. 5 illustrates a side view of exemplary “double-pane” and “triple-pane” type electrochromic devices.

FIG. 6A illustrates sunglasses made using cookie-cut substrates of PET-ITO and the in situ approach; the electrochromic material is in the neutral state at left and oxidized state at right.

FIGS. 6B and 6C illustrate sunglasses attached to a simple frame using frame-side battery compartments and switches (C); the electrochromic material is shown in each of its colored states (top=oxidized, bottom=neutral) (B).

FIG. 6D illustrates a pair of red/blue “3D glasses.”

### DETAILED DESCRIPTION

Disclosed herein are electrochromic devices prepared by an in situ formation of conjugated polymers. The electrochromic devices can be used in a variety of applications, including, but not limited to, eyewear, including glasses, goggles, safety equipment such as face shields and visors, windows, displays, patterned devices, and the like further described herein.

The in situ method is a facile, cost effective, and industrially scalable method for the formation of devices comprising a conjugated polymer by the in situ polymerization of an electroactive monomer, a conducting oligomer, a viologen, a conducting polymer precursor, or a combination thereof. As used herein, a “conjugated polymer” is synonymous to an electrochromic polymer, an electroactive polymer, or a conducting polymer. As used herein, the term “electroactive precursor” means any one or a combination of two or more of an electroactive monomer, a conducting oligomer, a viologen, a conducting polymer precursor. The conjugated polymer is formed inside a solid-state device by applying a voltage to the device to polymerize the electroactive precursor present in a mixture comprising a combination of an electrolyte composition and an electroactive precursor. The device can be fully assembled prior to the application of the voltage which effects the formation of the conjugated polymer via electrochemical polymerization. Such a process avoids many of the usual processing steps required to make such solid-state devices (e.g., an electrochromic device (ECD)). Such steps that are avoided include formation of a discrete, thin film of conjugated polymer on a substrate, formation of an electrolyte bath used for electrodeposition, disposal of the electrolyte bath, etc. There is also no need for special processing steps for device assembly, special synthetic steps for conjugated polymer preparation, and there is a significant avoidance of chemical waste in that electrolytic baths containing solvents and organic salts are not used.

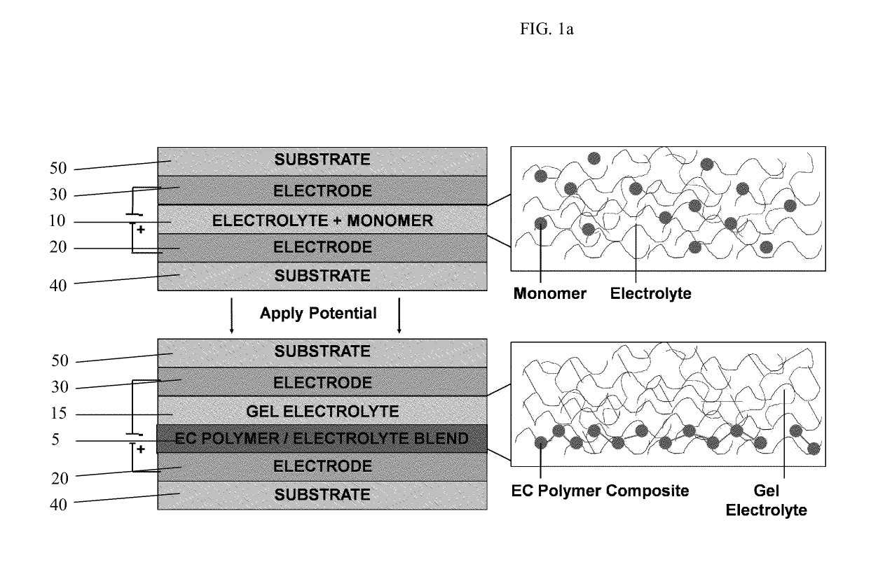

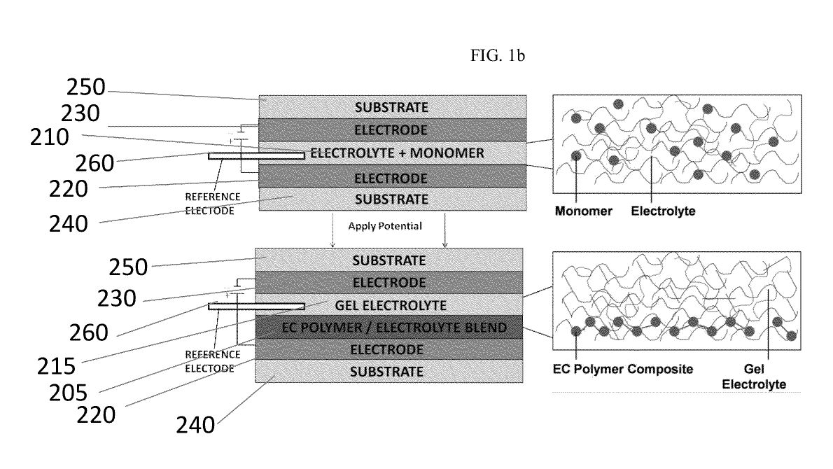

Also disclosed herein are solid-state devices prepared from the method. To prepare a device, only a mixture that comprises a combination of an electroactive precursor and an electrolyte composition is needed. Unlike traditionally formed conjugated polymer films prepared via electrochemical deposition that are then used to form an assembled device, the conjugated polymer is not formed as a discrete thin-film, but rather a polymer composite with the electrolyte composition. For example, when a gel electrolyte is used, the conjugated polymer is formed as a composite with the gel electrolyte matrix (See FIG. 1a). With this process, it is possible to form a variety of complex blends.

A further advantage of the process is that it can be used with solid or liquid electroactive precursors by selecting the appropriate electrolyte composition that would dissolve or disperse the electroactive precursor. Other advantages include the simplicity of color tuning via color mixing obtained by the copolymerization of various electroactive precursors. Still a further advantage is the formation of higher Photopic contrast when in situ polymerization is used, particularly when the electroactive precursors are electropolymerized within the composite of crosslinked electrolyte matrix and electroactive precursor. Not wishing to be bound by theory, it is hypothesized that the formation of a higher photopic contrast is due to less pi-pi stacking between the conjugated polymer chains, caused by the physical conformation of the polymer composite. Inter-chain interactions are therefore separated, and in the oxidized (conducting, bleached) state, this results in less inter-chain mobility of the holes (absence of electrons) meaning there are fewer low-energy absorptions that will contribute to visible absorption in the oxidized state and ultimately a higher photopic contrast is observed.

When in situ polymerization is used, the conjugated polymer formed within the crosslinked gel electrolyte results in a gradient composite due to diffusion/electrophoretic controlled polymerization kinetics (see FIG. 1a). The concentration of conjugated polymer is not even throughout the composite. Such a gradient nature is not found in electrodeposited films or bulk-chemical-polymerized homogenous composites.

Furthermore, solid-state devices prepared by the in situ polymerization method exhibit reduced haze (below 3%) as compared to compact films. It is believed that there is less scattering of light due to homogeneity of the conjugated polymer within the composite such that no polymer particle aggregates are formed that can scatter light.

Unlike other technologies, the devices prepared by in situ polymerization method are functional in a wide range of temperatures. In one embodiment, the devices prepared by in situ polymerization method are functional from about −30° C. to about 50° C.

The device can be designed for user-controlled color changes, by the use of a switching means.

In one embodiment, a method to make a solid-state device comprises providing a device comprising at least two electrodes, a combination of an electrolyte composition and an electroactive precursor disposed between the electrodes, and a potential source in electrical connection with at least two electrodes; and applying a voltage to the device to polymerize the electroactive precursor to form a composite of a conjugated polymer and electrolyte composition. Further within this embodiment, the providing a device comprises mixing an electrolyte composition and an electroactive precursor to form a combination of the electrolyte composition and the electroactive precursor. The method further comprises disposing the combination of the electrolyte composition and the electroactive precursor between at least two electrodes.

When in situ polymerization is used, the application of a voltage causes diffusive migration of the electroactive precursor present to the working electrode and the subsequent formation of the conjugated polymer in and around a crosslinked matrix of the gel electrolyte to form a composite. In another embodiment, a gel electrolyte precursor is used and the voltage is applied to form the conjugated polymer prior to the crosslinking of the gel electrolyte precursor to gel electrolyte. In another embodiment, the polymerization of the electroactive precursor and the crosslinking of the gel electrolyte precursor are performed at the same time.

The electrolyte compositions for use in the solid-state device include those known for use in electrochromic devices. The electrolyte composition may include metal salts, organic salts (e.g., ionic liquids), inorganic salts, and the like, and a combination thereof.

In one embodiment the electrolyte composition is a gel electrolyte. The gel electrolyte layer can be formed by coating a gel electrolyte precursor mixture comprising a gel electrolyte precursor. The gel electrolyte precursor can be monomeric or polymeric. In particular, the gel precursor is a crosslinkable polymer. The crosslinkable polymer can comprise polymerizable end groups, polymerizable side-chain groups, or a combination thereof attached to a polymer backbone. Exemplary polymer backbones include polyamides, polyimides, polycarbonates, polyesters, polyethers, polymethacrylates, polyacrylates, polysilanes, polysiloxanes, polyvinylacetates, polymethacrylonitriles, polyacrylonitriles, polyvinylphenols, polyvinylalcohols, polyvinylidenehalides, and co-polymers and combinations thereof. More specifically, the gel precursor is a cross-linkable polyether. Exemplary polyethers include poly(alkylene ethers) and poly(alkylene glycol)s comprising ethyleneoxy, propyleneoxy, and butyleneoxy repeating units. Hydroxyl end groups of poly(alkylene glycols) can be capped with polymerizable vinyl groups including (meth)acrylate and styryl vinyl groups to form a crosslinkable polyether. In particular, the crosslinkable polymer is selected from the group consisting of poly(ethylene glycol) diacrylate (PEG-DA), poly(propylene glycol) diacrylate (PPG-DA), poly(butylene glycol) diacrylate (PBG-DA), poly(ethylene oxide) (PEO), poly(propylene oxide) (PPO), poly(butylene oxide) (PBO), and combinations thereof. The crosslinkable polymer can also be a copolymer or a block copolymer comprising ethyleneoxy, propylenoxy, or butyleneoxy repeating units. In a specific embodiment, the gel precursor is crosslinkable polymer comprising a mixture of PEG-DA and propylene carbonate, wherein the propylene carbonate:PEG-DA weight ratio is from 95:5 to 5:95, more particularly 90:10 to 10:90, and even more particularly 60:40 to 40:60 or 50:50.

The electrolyte composition can comprise an alkali metal ion of Li, Na, or K. Exemplary electrolytes, where M represents an alkali metal ion, include MClO₄, MPF₆, MBF₄, MAsF₆, MSbF₆, MCF₃SO₃, MCF₃CO₂, M₂C₂F₄(SO₃)₂, MN(CF₃SO₂)₂, MN(C₂F₅SO₂)₂, MC(CF₃SO₂)₃, MCₙF₂ₙ₊₁SO₃ (2≦n≦3), MN(RfOSO₂)₂ (wherein Rf is a fluoroalkyl group), MOH, or combinations of the foregoing electrolytes. In particular, the electrolyte composition comprises a lithium salt. More particularly, the lithium salt is lithium trifluoromethanesulfonate. Other suitable salts include tetra-n-butylammonium tetrafluoroborate (TBABF₄); tetra-n-butylammonium hexafluorophosphate (TBAPF₆); and combinations thereof. When a gel electrolyte is used, the concentration of the electrolyte salt may be about 0.01 to about 30% by weight of the gel electrolyte precursor, specifically about 5 to about 20% by weight, and yet more specifically about 10 to about 15% by weight of the gel electrolyte precursor.

The gel electrolyte precursor mixture can also comprise a solvent or plasticizer to enhance the ionic conductivity of the electrolyte. These may be high boiling organic liquids such as carbonates, their blends or other materials like dimethylformamide (DMF). In particular the solvent can be a carbonate, for example alkylene and alkylyne carbonates such as dimethyl carbonate, ethylmethyl carbonate, methylpropyl carbonate, methylbutyl carbonate, methylpentyl carbonate, diethyl carbonate, ethylpropyl carbonate, ethylbutyl carbonate, dipropyl carbonate, propylene carbonate, ethylene carbonate, propylyne carbonate, and combinations thereof. The amount of solvent and/or plasticizer added to the gel electrolyte precursor mixture can range from about 0 to about 50% by weight of the gel electrolyte precursor mixture, specifically about 10 to about 40% by weight, and more specifically about 20 to about 30% by weight of the gel electrolyte precursor mixture.

The gel electrolyte precursor mixture can further comprise other additives such as photochemical sensitizers, free radical initiators, and diluent polymers, providing the desired properties of the electrochromic device are not significantly adversely affected; for example, the ionic conductivity of the gel electrolyte, the switching speed of the electrochromic response, color contrast of the electrochromic response, adhesion of the gel electrolyte to the substrate, and flexibility of the electrodes.

In one embodiment, the gel electrolyte precursor mixture does not comprise a plasticizer. In another embodiment, the gel electrolyte does comprise a plasticizer.

The electrolyte composition may contain an ionic liquid. Ionic liquids are organic salts with melting points under about 100° C. Other ionic liquids have melting points of less than room temperature (˜22° C.). Examples of ionic liquids that may be used in the electrolyte composition include imidazolium, pyridinium, phosphonium or tetralkylammonium based compounds, for example, 1-ethyl-3-methylimidazolium tosylate, 1-butyl-3-methylimidazolium octyl sulfate; 1-butyl-3-methylimidazolium 2-(2-methoxyethoxy)ethyl sulfate; 1-ethyl-3-methylimidazolium bis(pentafluoroethylsulfonyl)imide; 1-ethyl-3-methylimidazolium bis(trifluoromethylsulfonyl)imide; 1-ethyl-3-methylimidazolium bromide; 1-ethyl-3-methylimidazolium hexafluorophosphate; 1-butyl-3-methylimidazolium bromide; 1-butyl-3-methylimidazolium trifluoromethane sulfonate; 1,2-dimethyl-3-propylimidazolium tris(trifluoromethylsulfonyl)methide; 1,2-dimethyl-3-propylimidazolium bis(trifluoromethylsulfonyl)imide; 3-methyl-1-propylpyridinium bis(trifluormethylsulfonyl)imide; 1-butyl-3-methylpyridinium bis(trifluormethylsulfonyl)imide; 1-butyl-4-methylpyridinium chloride; 1-butyl-4-methylpyridinium hexafluorophosphate; 1-butyl-4-methylpyridinium tetrafluoroborate; 1-n-butyl-3-methylimidazolium hexafluorophosphate (n-BMIM PF₆); 1-butyl-3-methylimidazolium tetrafluoroborate (BMIM BF₄); phosphonium dodecylbenzenesulfonate; phosphonium methanesulfonate; and mixtures of these.

The amount of ionic liquid that can be used in the gel electrolyte precursor mixture can range from about 10% to about 80% by weight, specifically about 20% to about 70% by weight, more specifically about 30% to about 60% by weight, and yet more specifically about 40% to about 50% by weight of the gel electrolyte precursor mixture.

The gel electrolyte precursor can be converted to a gel via radical crosslinking initiated by thermal methods, or in particular by exposure to ultraviolet (UV) radiation. In an exemplary embodiment, the wavelength of UV irradiation is about 365 nm although other wavelengths can be used.

The gel electrolyte precursor mixture may comprise a thermal initiator or a photoinitiator. Exemplary photoinitiators include benzophenone, 2,2-dimethoxy-2-phenylacetophenone (DMPAP), dimethoxyacetophenone, xanthone, and thioxanthone. In one embodiment the initiator may include 2,2-dimethoxy-2-phenyl-acetophenone (DMPAP).

Crosslinking may also be thermally induced at about 40° C. to about 150° C., specifically about 50° C. to about 80° C., and more specifically about 60° C. to about 70° C. using a thermal initiator. Exemplary thermal initiators include peroxide initiators such as benzyl peroxide (BPO), or azo bis isobutylnitrile (AIBN). 80° C., but anywhere between 50° and 150° C.

In one embodiment, the gel electrolyte precursor mixture comprises the electrolyte salt (e.g. metal salts, organic salts (e.g., ionic liquids), inorganic salts, or a combination thereof) and the gel precursor in a weight ratio of 1 to 10, with a 0.002 to 1 to 10 ratio of initiator to electrolyte to gel precursor, by weight.

Exemplary gel polymer electrolytes include those described in U.S. Pat. No. 7,586,663 and U.S. Pat. No. 7,626,748, both to Radmard et al.

The electroactive precursor is polymerized in situ in the assembled device by applying voltage (oxidative potential) across the device. The electroactive precursor irreversibly converts to the conjugated polymer and can be switched as normal, with a moderate reduction in optical contrast.

The electroactive precursor can be any one or a combination of an electroactive monomer, a conducting oligomer, a viologen, a conducting polymer precursor. Examples of suitable electroactive monomers include those known in the art to exhibit electroactivity when polymerized, including but not limited to thiophene, substituted thiophene, carbazole, 3,4-ethylenedioxythiophene, thieno[3,4-b]thiophene, substituted thieno[3,4-b]thiophene, dithieno[3,4-b:3′,4′-d]thiophene, thieno[3,4-b]furan, substituted thieno[3,4-b]furan, bithiophene, substituted bithiophene, pyrrole, substituted pyrrole, acetylene, phenylene, substituted phenylene, naphthalene, substituted naphthalene, biphenyl and terphenyl and their substituted versions, phenylene vinylene (e.g., p-phenylene vinylene), substituted phenylene vinylene, aniline, substituted aniline, indole, substituted indole, the monomers disclosed herein as structures (I)-(XXXI), combinations thereof, and the like.

The electroactive monomer can be selected from cathodically coloring materials, anodically coloring materials, or a combination thereof.

Cathodically coloring materials have a band gap (E_{g}) less than or equal to 2.0 eV in the neutral state. A cathodically coloring material changes color when oxidized (p-doped). The change in visible color can be from colored in the neutral state to colorless in the oxidized state, or from one color in the neutral state to a different color in the oxidized state. Cathodically coloring materials include, but are not limited to, polymers derived from a 3,4-alkylenedioxyheterocycle such as an alkylenedioxypyrrole, alkylenedioxythiophene or alkylenedioxyfuran. These further include polymers derived from 3,4-alkylenedioxyheterocycles comprising a bridge-alkyl substituted 3,4-alkylenedioxythiophene, such as 3,4-(2,2-dimethylpropylene)dioxythiophene (PropOT-(Me)₂), 3,4-(2,2-dihexylpropylene)dioxythiophene (PropOT-(hexyl)₂), or 3,4-(2,2-bis(2-ethylhexyl)propylene)dioxythiophene (PropOT-(ethylhexyl)₂). Herein, “colored” means the material absorbs one or more radiation wavelengths in the visible region (400 nm to 700 nm) in sufficient quantity that the reflected or transmitted visible light by the material is visually detectable to the human eye as a color (red, green, blue or a combination thereof).

An anodically coloring material has a band gap E_{g} greater than 3.0 eV in its neutral state. An anodically coloring material changes color when reduced (n-doped). The material can be colored in the neutral state and colorless in reduced state, or have one color in the neutral state and a different color in the reduced state. An anodically coloring material can also comprise polymers derived from a 3,4-alkylenedioxyheterocycle or derived from an alkylenedioxyheterocycle such as alkylenedioxypyrrole, alkylenedioxythiophene or alkylenedioxyfuran. Exemplary 3,4-alkylenedioxyheterocycle monomers to prepare anodically coloring polymers include an N-alkyl substituted 3,4-alkylenedioxypyrrole, such as N-propyl-3,4-propylenedioxypyrrole (N-Pr PropOP), N-Gly-3,4-propylenedioxypyrrole (N-Gly PropOP), where N-Gly designates a glycinamide adduct of pyrrole group, or N-propane sulfonated PropOP (PropOP-NPrS).

In one embodiment EDOT is used to prepare a cathodically coloring conjugated polymer and 3,6-bis(2-(3,4-ethylenedioxy)thienyl)-N-methylcarbazole (BEDOT-NMCz) is used to prepare an anodically coloring conjugated polymer which is complementary to PEDOT when on the counter electrode.

Suitable electroactive monomers include 3,4-ethylenedioxythiophene, 3,4-ethylenedithiathiophene, 3,4-ethylenedioxypyrrole, 3,4-ethylenedithiapyrrole, 3,4-ethylenedioxyfuran, 3,4-ethylenedithiafuran, and derivatives having the general structure (I):

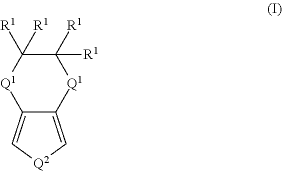

wherein each occurrence of Q¹ is independently S, O, or Se; Q² is S, O, or N—R² wherein R² is hydrogen or C₁-C₆ alkyl; and each occurrence of R¹ is independently hydrogen, C₁-C₁₂ alkyl, C₁-C₁₂ alkyl-OH, C₁-C₁₂ haloalkyl, C₁-C₁₂ alkoxy, C₁-C₁₂ haloalkoxy, aryl, —C₁-C₆ alkyl-O—C₁-C₆ alkyl, or —C₁-C₆ alkyl-O-aryl. In one embodiment, each occurrence of R¹ is hydrogen. In one embodiment, each Q¹ is O and Q² is S. In another embodiment, each Q¹ is O, Q² is S, and one R¹ is C₁-C₁₂ alkyl, C₁-C₁₂ alkyl-OH, C₁-C₁₂ haloalkyl, C₁-C₁₂ alkoxy, C₁-C₁₂ haloalkoxy, —C₁-C₆ alkyl-O—C₁-C₆ alkyl, while the remaining R¹ are hydrogen. In another embodiment, each Q¹ is O, Q² is S, and one R¹ is C₁ alkyl-OH, while the remaining R¹ are hydrogen. A specific electroactive monomer is 3,4-ethylenedioxythiophene or EDOT.

Another suitable electroactive monomer includes an unsubstituted and 2- or 6-substituted thieno[3,4-b]thiophene and thieno[3,4-b]furan having the general structures (II), (III), and (IV):

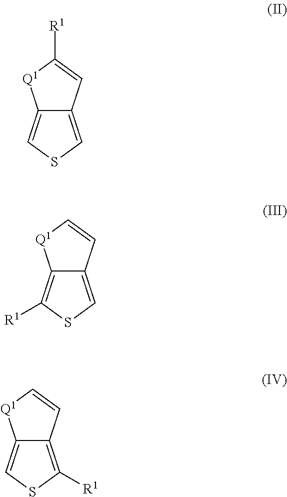

wherein Q¹ is S, O, or Se; and R¹ is hydrogen, C₁-C₁₂ alkyl, C₁-C₁₂ haloalkyl including perfluoroalkyl, C₁-C₁₂ alkoxy, C₁-C₁₂ haloalkoxy, aryl, —C₁-C₆ alkyl-O—C₁-C₆ alkyl, or —C₁-C₆ alkyl-O-aryl. In one embodiment, Q¹ is S and R¹ is hydrogen. In another embodiment, Q¹ is O and R¹ is hydrogen. In yet another embodiment, Q¹ is Se and R¹ is hydrogen.

Another suitable electroactive monomer includes substituted 3,4-propylenedioxythiophene (PropOT) monomers according to the general structure (V):

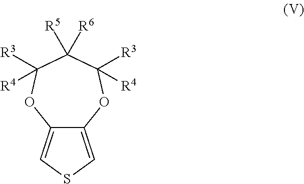

wherein each instance of R³, R⁴, R⁵, and R⁶ independently is hydrogen; optionally substituted C₁-C₂₀ alkyl, C₁-C₂₀ haloalkyl, aryl, C₁-C₂₀ alkoxy, C₁-C₂₀ haloalkoxy, aryloxy, —C₁-C₁₀ alkyl-O—C₁-C₁₀ alkyl, —C₁-C₁₀ alkyl-O-aryl, —C₁-C₁₀ alkyl-aryl; or hydroxyl. The C₁-C₂₀ alkyl, C₁-C₂₀ haloalkyl, aryl, C₁-C₂₀ alkoxy, C₁-C₂₀ haloalkoxy, aryloxy, —C₁-C₁₀ alkyl-O—C₁-C₁₀ alkyl, —C₁-C₁₀ alkyl-O-aryl, or —C₁-C₁₀ alkyl-aryl groups each may be optionally substituted with one or more of C₁-C₂₀ alkyl; aryl; halogen; hydroxyl; —N—(R²)₂ wherein each R² is independently hydrogen or C₁-C₆ alkyl; cyano; nitro; —COOH; —S(═O)C₀-C₁₀ alkyl; or —S(═O)₂C₀-C₁₀ alkyl. In one embodiment, R⁵ and R⁶ are both hydrogen. In another embodiment, R⁵ and R⁶ are both hydrogen, each instance of R³ independently is C₁-C₁₀ alkyl or benzyl, and each instance of R⁴ independently is hydrogen, C₁-C₁₀ alkyl, or benzyl. In another embodiment, R⁵ and R⁶ are both hydrogen, each instance of R³ independently is C₁-C₅ alkyl or benzyl and each instance of R⁴ independently is hydrogen, C₁-C₅ alkyl, or benzyl. In yet another embodiment, each instance of R³ and R⁴ are hydrogen, and one of R⁵ and R⁶ is hydroxyl while the other is hydrogen.

Other suitable electroactive monomers include pyrrole, furan, thiophene, and derivatives having the general structure (VI):

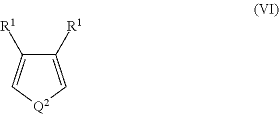

wherein Q² is S, O, or N—R² wherein R² is hydrogen or C₁-C₆ alkyl; and each occurrence of R¹ is independently hydrogen, C₁-C₁₂ alkyl, C₁-C₁₂ haloalkyl, C₁-C₁₂ alkoxy, C₁-C₁₂ haloalkoxy, aryl, —C₁-C₆ alkyl-O—C₁-C₆ alkyl, or —C₁-C₆ alkyl-O-aryl. An exemplary substituted pyrrole includes n-methylpyrrole. Exemplary substituted thiophenes include 3-methylthiophene and 3-hexylthiophene.

Additional electroactive monomers include isathianaphthene, pyridothiophene, pyrizinothiophene, and derivatives having the general structure (VII):

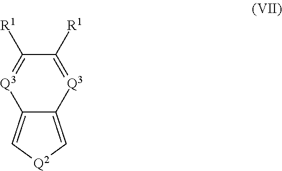

wherein Q² is S, O, or N—R² wherein R² is hydrogen or C₁-C₆ alkyl; each occurrence of Q³ is independently CH or N; and each occurrence of R¹ is independently hydrogen, C₁-C₁₂ alkyl, C₁-C₁₂ haloalkyl, C₁-C₁₂ alkoxy, C₁-C₁₂ haloalkoxy, aryl, —C₁-C₆ alkyl-O—C₁-C₆ alkyl, or —C₁-C₆ alkyl-O-aryl.

Still other electroactive monomers include oxazole, thiazole, and derivatives having the general structure (VIII):

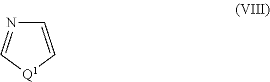

wherein Q¹ is S or O.

Additional electroactive monomers include the class of compounds according to structure (IX):

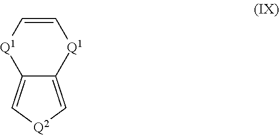

wherein Q² is S, O, or N—R² wherein R² is hydrogen or C₁-C₆ alkyl; and each occurrence of Q¹ is independently S or O.

Additional electroactive monomers (or oligomers) include bithiophene, bifuran, bipyrrole, and derivatives having the following general structure (X):

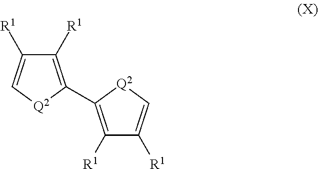

wherein each occurrence of Q² is independently S, O, or N—R² wherein R² is hydrogen or C₁-C₆ alkyl; and each occurrence of R¹ is independently hydrogen, C₁-C₁₂ alkyl, C₁-C₁₂ haloalkyl, C₁-C₁₂ alkoxy, C₁-C₁₂ haloalkoxy, aryl, —C₁-C₆ alkyl-O—C₁-C₆ alkyl, or —C₁-C₆ alkyl-O-aryl.

Electroactive monomers (or oligomers) include terthiophene, terfuran, terpyrrole, and derivatives having the following general structure (XI):

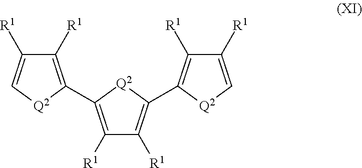

wherein each occurrence of Q² is independently S, O, or N—R² wherein R² is hydrogen or C₁-C₆ alkyl; and each occurrence of R¹ is independently hydrogen, C₁-C₁₂ alkyl, C₁-C₁₂ haloalkyl, C₁-C₁₂ alkoxy, C₁-C₁₂ haloalkoxy, aryl, —C₁-C₆ alkyl-O—C₁-C₆ alkyl, or —C₁-C₆ alkyl-O-aryl.

Additional electroactive monomers include thienothiophene, thienofuran, thienopyrrole, furanylpyrrole, furanylfuran, pyrolylpyrrole, and derivatives having the following general structure (XII):

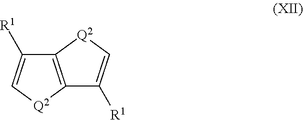

wherein each occurrence of Q² is independently S, O, or N—R² wherein R² is hydrogen or C₁-C₆ alkyl; and each occurrence of R¹ is independently hydrogen, C₁-C₁₂ alkyl, C₁-C₁₂ haloalkyl, C₁-C₁₂ alkoxy, C₁-C₁₂ haloalkoxy, aryl, —C₁-C₆ alkyl-O—C₁-C₆ alkyl, or —C₁-C₆ alkyl-O-aryl.

Still other electroactive monomers include dithienothiophene, difuranylthiophene, dipyrrolylthiophene, dithienofuran, dipyrrolylfuran, dipyrrolylpyrrole, and derivatives having the following general structure (XIII):

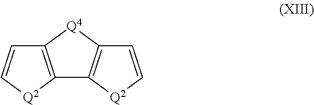

wherein each occurrence of Q² is independently S, O, or N—R² wherein R² is hydrogen or C₁-C₆ alkyl; Q⁴ is C(R⁷)₂, S, O, or N—R²; and each occurrence of R⁷ is independently hydrogen, C₁-C₁₂ alkyl, C₁-C₁₂ haloalkyl, C₁-C₁₂ alkoxy, C₁-C₁₂ haloalkoxy, aryl, —C₁-C₆ alkyl-O—C₁-C₆ alkyl, or —C₁-C₆ alkyl-O-aryl.

Additional electroactive monomers include dithienylcyclopentenone, difuranylcyclopentenone, dipyrrolylcyclopentenone and derivatives having the following general structure (XIV):

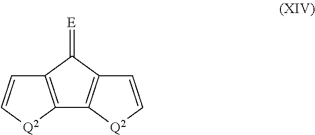

wherein each occurrence of Q² is independently S, O, or N—R² wherein R² is hydrogen or C₁-C₆ alkyl; and E is O or C(R⁷)₂, wherein each occurrence of R⁷ is an electron withdrawing group.

Other suitable electroactive monomers (or oligomers) include those having the following general structure (XV):

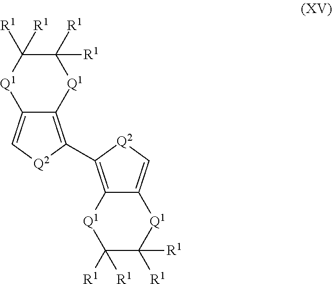

wherein each occurrence of Q¹ is independently S or O; each occurrence of Q² is independently S, O, or N—R² wherein R² is hydrogen or C₁-C₆ alkyl; each occurrence of R¹ is independently hydrogen, C₁-C₁₂ alkyl, C₁-C₁₂ haloalkyl, C₁-C₁₂ alkoxy, C₁-C₁₂ haloalkoxy, aryl, —C₁-C₆ alkyl-O—C₁-C₆ alkyl, or —C₁-C₆ alkyl-O-aryl. In one embodiment, each occurrence of Q¹ is o; each occurrence of Q² is S; and each occurrence of R¹ is hydrogen.

Additional electroactive monomers (or oligomers) include dithienovinylene, difuranylvinylene, and dipyrrolylvinylene according to the structure (XVI):

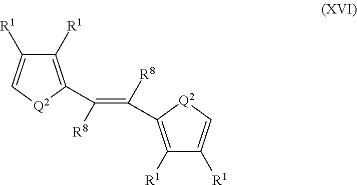

wherein each occurrence of Q² is independently S, O, or N—R² wherein R² is hydrogen or C₁-C₆ alkyl; each occurrence of R¹ is independently hydrogen, C₁-C₁₂ alkyl, C₁-C₁₂ haloalkyl, C₁-C₁₂ alkoxy, C₁-C₁₂ haloalkoxy, aryl, —C₁-C₆ alkyl-O—C₁-C₆ alkyl, or —C₁-C₆ alkyl-O-aryl; and each occurrence of R⁸ is hydrogen, C₁-C₆ alkyl, or cyano.

Other electroactive monomers (or oligomers) include 1,2-trans(3,4-ethylenedioxythienyl)vinylene, 1,2-trans(3,4-ethylenedioxyfuranyl)vinylene, 1,2-trans(3,4-ethylenedioxypyrrolyl)vinylene, and derivatives according to the structure (XVII):

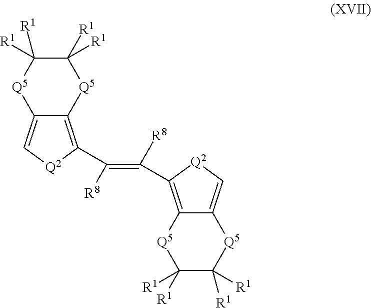

wherein each occurrence of Q⁵ is independently CH₂, S, or O; each occurrence of Q² is independently S, O, or N—R² wherein R² is hydrogen or C₁-C₆ alkyl; each occurrence of R¹ is independently hydrogen, C₁-C₁₂ alkyl, C₁-C₁₂ haloalkyl, C₁-C₁₂ alkoxy, C₁-C₁₂ haloalkoxy, aryl, —C₁-C₆ alkyl-O—C₁-C₆ alkyl, or —C₁-C₆ alkyl-O-aryl; and each occurrence of R⁸ is hydrogen, C₁-C₆ alkyl, or cyano.

Additional electroactive monomers (or oligomers) include the class bis-thienylarylenes, bis-furanylarylenes, bis-pyrrolylarylenes and derivatives according to the structure (XVIII):

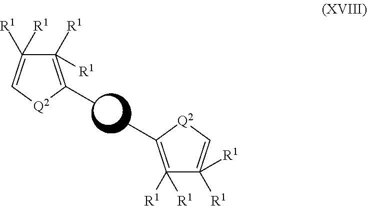

wherein each occurrence of Q² is independently S, O, or N—R² wherein R² is hydrogen or C₁-C₆ alkyl; each occurrence of R¹ is independently hydrogen, C₁-C₁₂ alkyl, C₁-C₁₂ haloalkyl, C₁-C₁₂ alkoxy, C₁-C₁₂ haloalkoxy, aryl, —C₁-C₆ alkyl-O—C₁-C₆ alkyl, or —C₁-C₆ alkyl-O-aryl; and

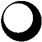

represents an aryl. Exemplary aryl groups include furan, pyrrole, N-substituted pyrrole, phenyl, biphenyl, thiophene, fluorene, 9-alkyl-9H-carbazole, and the like.

Other electroactive monomers (or olgiomers) include the class of bis(3,4-ethylenedioxythienyl)arylenes, related compounds, and derivatives according to the structure (XIX):

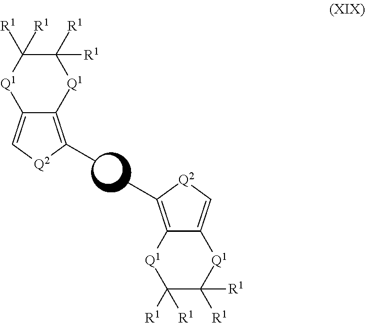

wherein each occurrence of Q¹ is independently S or O; each occurrence of Q² is independently S, O, or N—R² wherein R² is hydrogen or C₁-C₆ alkyl; each occurrence of R¹ is independently hydrogen, C₁-C₁₂ alkyl, C₁-C₁₂ haloalkyl, C₁-C₁₂ alkoxy, C₁-C₁₂ haloalkoxy, aryl, —C₁-C₆ alkyl-O—C₁-C₆ alkyl, or —C₁-C₆ alkyl-O-aryl; and

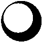

represents an aryl.

Other exemplary electroactive monomers (or oligomers) include bis(3,4-ethylenedioxythienyl)arylenes according to structure (XIX) includes the compound wherein all Q¹ are O, both Q² are S, all R¹ are hydrogen, and

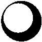

is phenyl linked at the 1 and 4 positions. Another exemplary compound is where all Q¹ are O, both Q² are S, all R¹ are hydrogen, and

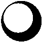

is thiophene linked at the 2 and 5 positions (bisEDOT-thiophene).

Additional electroactive monomers (or oligomers) include the class of compounds according to structure (XX):

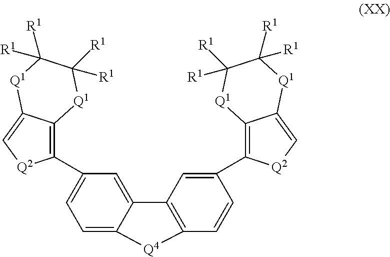

wherein each occurrence of Q¹ is independently S or O; each occurrence of Q² is independently S, O, or N—R² wherein R² is hydrogen or C₁-C₆ alkyl; Q⁴ is C(R¹)₂, S, O, or N—R²; and each occurrence of R¹ is independently hydrogen, C₁-C₁₂ alkyl, C₁-C₁₂ haloalkyl, C₁-C₁₂ alkoxy, C₁-C₁₂ haloalkoxy, aryl, —C₁-C₆ alkyl-O—C₁-C₆ alkyl, or —C₁-C₆ alkyl-O-aryl. In one embodiment, each occurrence of Q¹ is O; each occurrence of Q² is S; each occurrence of R¹ is hydrogen; and R² is methyl.

Still other electroactive monomers (or oligomers) include the class of compounds according to structure (XXI):

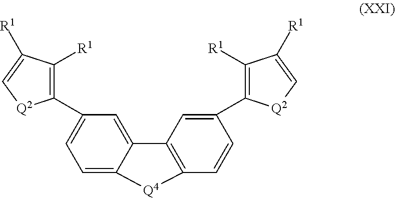

wherein each occurrence of Q² is independently S, O, or N—R² wherein R² is hydrogen or C₁-C₆ alkyl; Q⁴ is C(R¹)₂, S, O, or N—R²; and each occurrence of R¹ is independently hydrogen, C₁-C₁₂ alkyl, C₁-C₁₂ haloalkyl, C₁-C₁₂ alkoxy, C₁-C₁₂ haloalkoxy, aryl, —C₁-C₆ alkyl-O—C₁-C₆ alkyl, or —C₁-C₆ alkyl-O-aryl.

Additional electroactive monomers include the class of compounds according to structure (XXII):

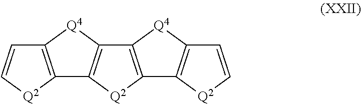

wherein each occurrence of Q² is independently S, O, or N—R² wherein R² is hydrogen or C₁-C₆ alkyl; each occurrence of Q⁴ is C(R¹)₂, S, O, or N—R²; and each occurrence of R¹ is independently hydrogen, C₁-C₁₂ alkyl, C₁-C₁₂ haloalkyl, C₁-C₁₂ alkoxy, C₁-C₁₂ haloalkoxy, aryl, —C₁-C₆ alkyl-O—C₁-C₆ alkyl, or —C₁-C₆ alkyl-O-aryl.

Other exemplary monomers (or oligomers) include the class of compounds according to structure (XXIII):

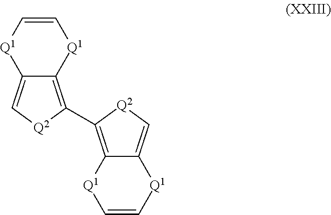

wherein each occurrence of Q² is independently S, O, or N—R² wherein R² is hydrogen or C₁-C₆ alkyl; and each occurrence of Q¹ is independently S or O.

Exemplary electroactive monomers include the class of compounds according to structure (XXIV):

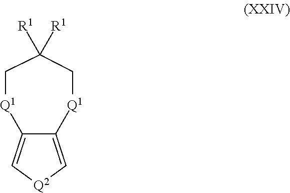

wherein Q² is S, O, or N—R² wherein R² is hydrogen or C₁-C₆ alkyl; each occurrence of Q¹ is independently S or O; and each occurrence of R¹ is independently hydrogen, C₁-C₁₂ alkyl, C₁-C₁₂ haloalkyl, C₁-C₁₂ alkoxy, C₁-C₁₂ haloalkoxy, aryl, —C₁-C₆ alkyl-O—C₁-C₆ alkyl, —C₁-C₆ alkyl-aryl, —C₁-C₆ alkyl-O-aryl, or —C₁-C₆ alkyl-O-aryl. In one embodiment, one R¹ is methyl and the other R¹ is benzyl, —C₁-C₆ alkyl-O-phenyl, —C₁-C₆ alkyl-O-biphenyl, or —C₁-C₆ alkyl-biphenyl.

Additional electroactive monomers (or oligomers) include the class of compounds according to structure (XXV):

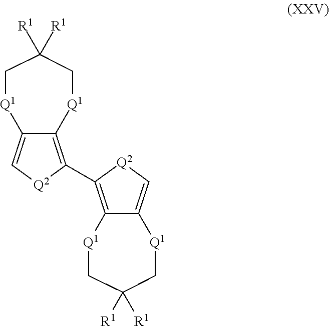

wherein each occurrence of Q² is independently S, O, or N—R² wherein R² is hydrogen or C₁-C₆ alkyl; each occurrence of Q¹ is independently S or O; and each occurrence of R¹ is independently hydrogen, C₁-C₁₂ alkyl, C₁-C₁₂ haloalkyl, C₁-C₁₂ alkoxy, C₁-C₁₂ haloalkoxy, aryl, —C₁-C₆ alkyl-O—C₁-C₆ alkyl, or —C₁-C₆ alkyl-O-aryl. In one embodiment, one R¹ is methyl and the other R¹ is —C₁-C₆ alkyl-O-phenyl or —C₁-C₆ alkyl-O-biphenyl per geminal carbon center.

Other electroactive monomers (or oligomers) include the class of compounds according to structure (XXVI):

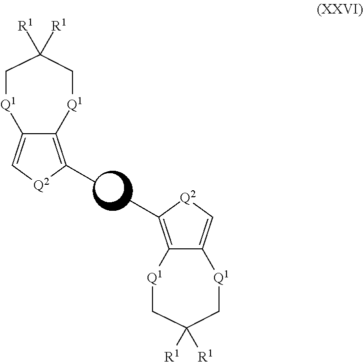

wherein each occurrence of Q² is independently S, O, or N—R² wherein R² is hydrogen or C₁-C₆ alkyl; each occurrence of Q¹ is independently S or O; each occurrence of R¹ is independently hydrogen, C₁-C₁₂ alkyl, C₁-C₁₂ haloalkyl, C₁-C₁₂ alkoxy, C₁-C₁₂ haloalkoxy, aryl, —C₁-C₆ alkyl-O—C₁-C₆ alkyl, or —C₁-C₆ alkyl-O-aryl; and

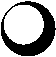

represents an aryl. In one embodiment, one R¹ is methyl and the other R¹ is —C₁-C₆ alkyl-O-phenyl or —C₁-C₆ alkyl-O-biphenyl per geminal carbon center.

Exemplary electroactive monomers include the class of compounds according to structure (XXVII):

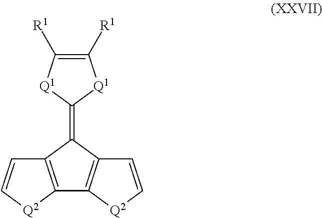

wherein each occurrence of Q² is independently S, O, or N—R² wherein R² is hydrogen or C₁-C₆ alkyl; each occurrence of Q¹ is independently S or O; and each occurrence of R¹ is independently hydrogen, C₁-C₁₂ alkyl, C₁-C₁₂ haloalkyl, C₁-C₁₂ alkoxy, C₁-C₁₂ haloalkoxy, aryl, —C₁-C₆ alkyl-O—C₁-C₆ alkyl, or —C₁-C₆ alkyl-O-aryl.

Additional electroactive monomers include the class of compounds according to structure (XXVIII):

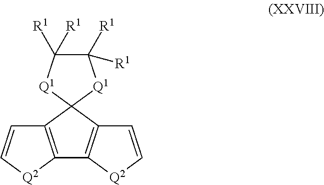

wherein each occurrence of Q² is independently S, O, or N—R² wherein R² is hydrogen or C₁-C₆ alkyl; each occurrence of Q¹ is independently S or O; and each occurrence of R¹ is independently hydrogen, C₁-C₁₂ alkyl, C₁-C₁₂ haloalkyl, C₁-C₁₂ alkoxy, C₁-C₁₂ haloalkoxy, aryl, —C₁-C₆ alkyl-O—C₁-C₆ alkyl, or —C₁-C₆ alkyl-O-aryl.

Another electroactive monomer includes aniline or substituted aniline according to structure (XXIX):

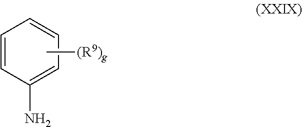

wherein g is 0, 1, 2, or 3; and each occurrence of R⁹ is independently C₁-C₁₂ alkyl, C₁-C₁₂ haloalkyl, C₁-C₁₂ alkoxy, C₁-C₁₂ haloalkoxy, aryl, —C₁-C₆ alkyl-O—C₁-C₆ alkyl, —C₁-C₆ alkyl-O-aryl, or N—R² wherein R² is hydrogen or C₁-C₆ alkyl.

Exemplary electroactive monomers include EDOT, PropOT, 1,4-bis[(3,4-ethylenedioxy)thien-2-yl)]-2,5-didodecyloxybenzene (BEDOT-B), benzothiadiazole (BTD), thieno[3,4-b]thiophene, thieno[3,4-b]furan, combinations thereof, and the like.

In one embodiment, a single type of electroactive monomer is employed to form a homopolymer. In another embodiment, a combination of two or more electroactive monomer types is used in a copolymerization process to form a conducting copolymer. As used herein “conducting polymer” is inclusive of conducting homopolymers and conducting copolymers unless otherwise indicated. Furthermore, in one embodiment, the polymerization may be conducted with a mixture of an electroactive monomer and a non-electroactive monomer. Color tuning can be achieved by the choice of monomers for copolymerization.

Other electroactive precursors include a conducting oligomer, a viologen, a conducting polymer precursor, or a combination thereof; each of which can be used in the place of, or in addition to, an electroactive monomer. It is to be understood that all embodiments that describe the use of monomers, there is the corresponding embodiment wherein the monomer component is replaced with a conducting oligomer, a viologen, a conducting polymer precursor, or a combination thereof.

In one embodiment, the conducting oligomer, conducting polymer precursor, or a combination thereof can be dissolved or dispersed in a gel electrolyte precursor and subsequently polymerized to a conjugated polymer by the application of a voltage.

In another embodiment, the conducting oligomer, conducting polymer precursor, or a combination thereof can be formed into a film or electrospun as a fiber and assembled into the solid-state device. After the device is assembled, a voltage is applied to polymerize the oligomer and/or precursor to form the conjugated polymer. Exemplary processes to electrospin conducting polymer precursors can be found in U.S. Patent Publ. 2007-0089845 to Sotzing et al., the relevant disclosure of which is incorporated by reference herein.

In another embodiment, a solid-state device prepared by the in situ process is comprised of fabric electrodes. Exemplary fabric electrodes are disclosed in U.S. Patent Publ. 2010/0245971 to Sotzing et al., incorporated herein by reference.

As used herein, viologens include a 4,4′-dipyridinium salt according to structures (XXX) and (XXXI):

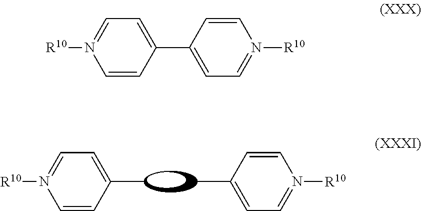

wherein each occurrence of R¹⁰ is independently C₁-C₁₂ alkyl, C₁-C₁₂ haloalkyl, aryl, —C₁-C₆ alkyl-O—C₁-C₆ alkyl, or —C₁-C₆ alkyl-O-aryl; and

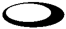

is C₂, C₄, or C₆ alkenylene, and aryl or heteroaryl, specifically two, three, four, or more aryl or heteroaryl groups lined together. Exemplary

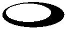

is phenylene, thiophene, and ethylene.
As used herein, a conducting polymer precursor includes a polymer or oligomer that can undergo further chain growth and/or crosslinking to produce the conjugated polymer.

Exemplary conducting polymer precursors include those of structures (XXXII) and (XXXIII):

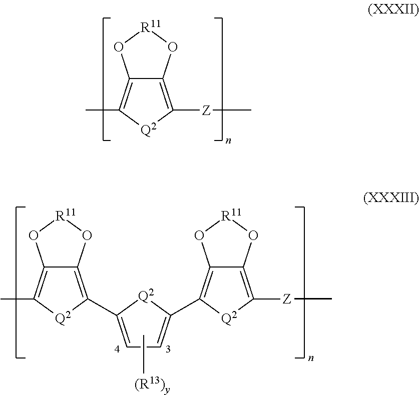

wherein n is an integer greater than 0; y is 0, 1, or 2; Q² is independently S, O, or N—R² wherein R² is hydrogen or C₁-C₆ alkyl; R¹¹ is a C₁-C₂₀ alkylene group; Z is a silylene group, for example —Si(R¹²)₂— or —Si(R¹²)₂—O—Si(R¹²)₂—, wherein each R¹² independently is a C₁-C₂₀ alkyl; and R¹³ is C₁-C₂₀ alkyl, C₁-C₂₀ alkoxy, C₁-C₂₀ thioalkyl, or C₁-C₂₀ aryl attached at the 3 and/or 4 position (shown) of the five-membered ring. R¹² can be, for example, methyl, ethyl, propyl, isopropyl, n-butyl, n-pentyl, n-hexyl, n-heptyl, or n-octyl. Exemplary R¹³ include methyl, ethyl, propyl, isopropyl, n-butyl, n-pentyl, n-hexyl, n-heptyl, n-octyl, phenyl, n-butylthio, n-octylthio-, phenylthio-, and methoxyphenyl.

In one embodiment, n is an integer from 1 to 1000, y is 0, R¹¹ is ethylene (—CH₂CH₂—), each Q² is sulfur, Z is —Si(R¹²)₂—, and R¹² is n-octyl. This 2,5-bis[(3,4-ethylenedioxy)thien-2-yl]-thiophene (BEDOT-T) silylene precursor polymer can be formed by the nickel-catalyzed coupling of 3,4-ethylenedioxythiophene with dibromothiophene, to form BEDOT-T, followed by deprotonation of BEDOT-T using n-BuLi to form a dianion of BEDOT-T, and reacting the dianion with dichlorodioctylsilane to form the BEDOT-T silylene precursor polymer. The weight average molecular weight of the BEDOT-T silylene precursor polymer can be 1000 to 100,000 g/mole, more specifically 1,000 to 10,000 g/mole.

In another specific embodiment, n is an integer from 1 to 1000, y is 0, R¹¹ is 2,2-dimethylpropylene (—CH₂C(CH₃)₂CH₂—), each Q² is sulfur, Z is —Si(R¹²)₂−O—Si(R¹²)₂—, and R¹² is methyl. This PropOT-Me₂ silylene precursor polymer can be prepared by transesterification of 3,4-dimethoxythiophene with 2,2-dimethyl-1,3-propanediol using para-toluene sulfonic acid (PTSA) or dodecylbenzene sulfonic acid (DBSA) as catalysts in anhydrous toluene to form PropOT-Me₂, deprotonating the PropOT-Me₂ using 2 equivalents of n-BuLi to form the dilithium dianion, and reacting the dilithium dianion with dichlorotetramethylsiloxane to form the PropOT-Me₂ silylene precursor polymer. The weight average molecular weight of the PropOT-Me₂ silylene precursor polymer can be 1000 to 100,000 g/mole, more specifically 1,000 to 5000 g/mole.

In addition to the heterocyclic ring systems shown in the precursors of formulas (XXXII) and (XXXIII), other aromatic heterocycle groups, e.g., those of formulas (I)-(XXVIII), can also be synthesized with silylene of formula Z.

Other suitable conducting polymer precursors include polynorbornylene conducting polymer precursor having an electroactive group (e.g. an electroactive monomer or oligomer such as those described above in formulas (I)-(XXVIII)) grafted onto the polymer backbone. Exemplary polynorbornylene conducting polymer precursors include those of structure (XXXIV):

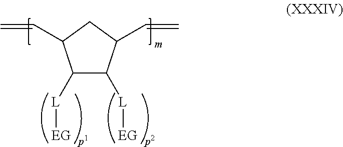

wherein L is a linking group containing 1-6 carbon atoms optionally interrupted by O, S, N(R¹⁴)₂, OC═O, C═OO, OC═OO, NR¹⁴C═O, C═ONR¹⁴, NR¹⁴C═ONR¹⁴, and the like, wherein R¹⁴ is H, C₁-C₁₂ alkyl, C₁-C₁₂ haloalkyl, aryl, —C₁-C₆ alkyl-O—C₁-C₆ alkyl, or —C₁-C₆ alkyl-O-aryl; EG is an electroactive group; p¹ is 0 or 1; p² is 0 or 1 with the proviso that at least one of p¹ and p² is 1; and m is about 3 to about 3000.

The polynorbornylene can be prepared by polymerization of a norbornylene monomer such as structure (XXXV):

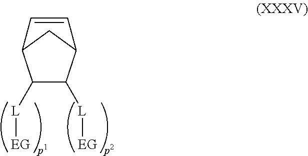

wherein L, EG, p¹ and p² are as defined above. The polymerization to form the polynorbornylene can be accomplished via ring opening metathesis polymerization (ROMP) using an appropriate catalyst (e.g. Grubb's alkylidene catalyst).

Exemplary polynorbornylenes include those of structures (XXXVI) and (XXXVII):

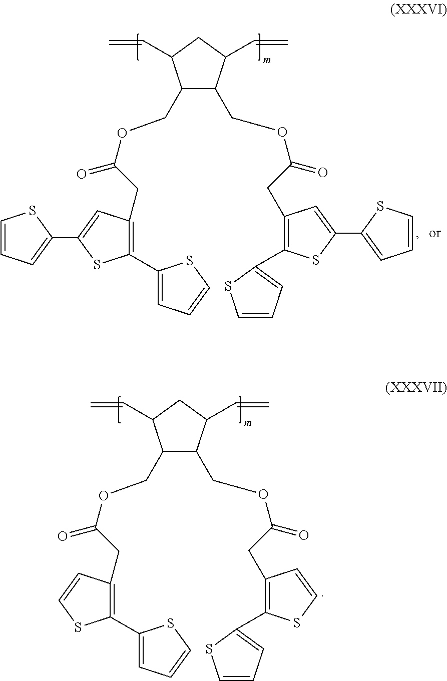

In another embodiment, the norbornylene monomer is used in combination with the electroactive monomer rather than the polynorbornylene conducting polymer precursor.

Additional electrochromic precursors are described, for example, in U.S. Pat. No. 7,321,012 to Sotzing, U.S. Patent Publs. 2007/0089845 to Sotzing et al., 2007/0008603 to Sotzing et al., and WO2007/008977 to Sotzing, the relevant disclosures of which are each incorporated by reference herein.

As used herein, electroactive oligomers include any dimer, trimer, or compound having multiple heterocycle units in length, wherein the heterocycle is an electroactive monomer. Exemplary oligomers have 2 to 10 units, specifically 2 to 7 units, and more specifically 2 to 3 units.

Compounds are described using standard nomenclature. For example, any position not substituted by any indicated group is understood to have its valency filled by a bond as indicated, or a hydrogen atom. A dash (“−”) that is not between two letters or symbols is used to indicate a point of attachment for a substituent. For example, “—CHO” is attached through carbon of the carbonyl group.

Unless otherwise indicated, the term “substituted” as used herein means replacement of one or more hydrogens with one or more substituents. Suitable substituents include, for example, hydroxyl, C₆-C₁₂ aryl, C₃-C₂₀ cycloalkyl, C₁-C₂₀ alkyl, halogen, C₁-C₂₀ alkoxy, C₁-C₂₀ alkylthio, C₁-C₂₀ haloalkyl, C₆-C₁₂ haloaryl, pyridyl, cyano, thiocyanato, nitro, amino, C₁-C₁₂ alkylamino, C₁-C₁₂ aminoalkyl, acyl, sulfoxyl, sulfonyl, amido, or carbamoyl.

As used herein, “alkyl” includes straight chain, branched, and cyclic saturated aliphatic hydrocarbon groups, having the specified number of carbon atoms, generally from 1 to about 20 carbon atoms, greater than 3 for the cyclic. Alkyl groups described herein typically have from 1 to about 20, specifically 3 to about 18, and more specifically about 6 to about 12 carbons atoms. Examples of alkyl include, but are not limited to, methyl, ethyl, n-propyl, isopropyl, n-butyl, 3-methylbutyl, t-butyl, n-pentyl, and sec-pentyl. As used herein, “cycloalkyl” indicates a monocyclic or multicyclic saturated or unsaturated hydrocarbon ring group, having the specified number of carbon atoms, usually from 3 to about 10 ring carbon atoms. Monocyclic cycloalkyl groups typically have from 3 to about 8 carbon ring atoms or from 3 to about 7 carbon ring atoms. Multicyclic cycloalkyl groups may have 2 or 3 fused cycloalkyl rings or contain bridged or caged cycloalkyl groups. Examples of cycloalkyl groups include cyclopropyl, cyclobutyl, cyclopentyl, or cyclohexyl as well as bridged or caged saturated ring groups such as norbornane or adamantane.

As used herein “haloalkyl” indicates both branched and straight-chain alkyl groups having the specified number of carbon atoms, substituted with 1 or more halogen atoms, generally up to the maximum allowable number of halogen atoms (“perhalogenated”). Examples of haloalkyl include, but are not limited to, trifluoromethyl, difluoromethyl, 2-fluoroethyl, and penta-fluoroethyl.

As used herein, “alkoxy” includes an alkyl group as defined above with the indicated number of carbon atoms attached through an oxygen bridge (—O—). Examples of alkoxy include, but are not limited to, methoxy, ethoxy, n-propoxy, i-propoxy, n-butoxy, 2-butoxy, t-butoxy, n-pentoxy, 2-pentoxy, 3-pentoxy, isopentoxy, neopentoxy, n-hexoxy, 2-hexoxy, 3-hexoxy, and 3-methylpentoxy.

“Haloalkoxy” indicates a haloalkyl group as defined above attached through an oxygen bridge.

As used herein, the term “aryl” indicates aromatic groups containing only carbon in the aromatic ring or rings. Such aromatic groups may be further substituted with carbon or non-carbon atoms or groups. Typical aryl groups contain 1 or 2 separate, fused, or pendant rings and from 6 to about 12 ring atoms, without heteroatoms as ring members. Where indicated aryl groups may be substituted. Such substitution may include fusion to a 5 to 7-membered saturated cyclic group that optionally contains 1 or 2 heteroatoms independently chosen from N, O, and S, to form, for example, a 3,4-methylenedioxy-phenyl group. Aryl groups include, for example, phenyl, naphthyl, including 1-naphthyl and 2-naphthyl, and bi-phenyl.

As used herein “heteroaryl” indicates aromatic groups containing carbon and one or more heteroatoms chosen from N, O, and S. Exemplary heteroaryls include oxazole, pyridine, pyrazole, thiophene, furan, isoquinoline, and the like. The heteroaryl groups may be substituted with one or more substituents.

As used herein, “halo” or “halogen” refers to fluoro, chloro, bromo, or iodo.

As used herein, “arylene” includes any divalent aromatic hydrocarbon or two or more aromatic hydrocarbons linked by a bond, a heteroatom (e.g., O, S, S(═O), S(═O)₂, etc.), a carbonyl group, an optionally substituted carbon chain, a carbon chain interrupted by a heteroatom, and the like.

The electrolyte/electroactive precursor mixture may optionally include an additional additive. The additive may be chosen so that it does not, unless desired, interfere with oxidative polymerization, interfere with color/contrast/switching, interfere with electrodes or other components in a degradative way. Exemplary additional additives may also be used in the combination of electrolyte and electroactive precursor, and include conductive fillers such as particulate copper, silver, nickel, aluminum, carbon black, graphene, carbon nanotubes, buckminister fullerene, and the like; non-conductive fillers such as talc, mica, wollastonite, silica, clay, dyes, pigments (zeolites), and the like.

In one embodiment, a filtering dye can be used to modulate the electrochromic coloration in the infrared, ultraviolet, visible region of the color spectrum, or a combination thereof (“color tuning”). The dyes can be organic and inorganic dyes. Exemplary dyes include indigo (blue), a naphthalene derivative (e.g. martius yellow, a deep yellow), an azo dye, a vat dye, a disperse dye, a viologen, an aniline, a carotenoid, a methine, a polymethine, a carbonyl dye, and the like.

In one embodiment, nanoparticles can be used to modulate the electrochromic coloration.

In another embodiment, the dye is a photochromic dye, such as a spirooxazine, and the like.

In another embodiment, a dye is used to achieve appropriate spectral darkening for applications such as personal protective equipment (e.g. welding visors, laser eye protection, or as protection against “flash bang” explosives and other blinding-light events). The dyes can be used to darken across all wavelengths (visible, UV, NIR).

As discussed above, the dye may be used in the electrolyte/electroactive precursor mixture. In alternative embodiments, the dye may be used inside a conductive substrate, as a thin film or coating separate from the composite comprising conjugated polymer and electrolyte composition, or as an external substrate filter.

The solid-state devices may further include a variety of substrate materials (flexible or rigid, planar or non-planar) used to house the electrolyte/electroactive precursor combination. Exemplary substrate materials include glass, plastic, silicon, a mineral, a semiconducting material, a ceramic, a metal, and the like, as well as a combination thereof. The substrate may be inherently conductive. Flexible substrate layers can be made from plastic. Exemplary plastics include polyethylene terephthalate (PET), poly(arylene ether), polyamide, polyether amide, etc. The substrate may include mirrored or reflective substrate material. A further advantage of the process is that the substrates do not require cleaning as compared to ITO substrates which need to be vigorously cleaned prior to immersion in an electrolyte bath otherwise any defect will cause unevenness of the film deposited.

The substrate for preparing the electrochromic device can be a polarized substrate.

Exemplary electrode materials for use in the electrochromic devices can include inorganic materials such as glass-indium doped tin oxide (glass-ITO), doped silicon, metals such as gold, platinum, aluminum, and the like, metal alloys such as stainless steel (“SS”), SS 316, SS316L, nickel and/or cobalt alloys such as Hastelloy-B® (Ni62/Mo28/Fe5/Cr/Mn/Si), Hastelloy-C®, and the like; and organic materials such as a conjugated polymer such as poly(3,4-ethylenedioxythiophene)-polystyrene sulfonate (PEDOT-PSS), conjugated polymers prepared from an electroactive monomer described herein, carbon black, carbon nanotubes, graphene, and the like.

In one embodiment, all of the electrodes are polyethylene terephthalate (PET)/indium-doped tin oxide (ITO) substrates.

The solid-state device can generally be fabricated by encasing a layer of the combination of electrolyte composition and electroactive precursor between at least two electrodes, wherein the electrodes are in electrical communication with the layer of the combination. In an exemplary generalized assembled solid-state device as shown in FIG. 1a, a layer of a combination of electrolyte composition (exemplified here with a gel electrolyte precursor) and electroactive monomer (10) is disposed between a first electrode (20) and a second electrode (30) and further (10) is in electrical communication with (20) and (30). Further, substrate layers (40) and (50) encase (10), (20), and (30). Upon application of a voltage, the solid-state device of FIG. 1 a includes a layer of a matrix containing electrolyte composition and conjugated polymer (5) disposed between a first electrode (20) and a portion of electrolyte composition (here a gel electrolyte formed by crosslinking the gel electrolyte precursor either before or after the application of voltage) (15); the first electrode (20) and second electrode (30) area in electrical communication with (15) and (5). Further, substrate layers (40) and (50) encase (5), (15), (20), and (30). The generalized device of FIG. 1a can be modified to replace the electroactive monomer with any electroactive precursor discussed herein.

FIG. 1b is a general schematic of a three-electrode assembled solid-state device comprising a reference electrode. In an exemplary generalized assembled solid-state device as shown in FIG. 1b, a layer of a combination of electrolyte composition (exemplified here with a gel electrolyte precursor) and electroactive monomer (210) is disposed between a first electrode (here the working electrode) (220) and a second electrode (here the counter electrode) (230) and further (210) is in electrical communication with (220) and (230) as well as reference electrode (260). Further, substrate layers (240) and (250) encase (210), (220), and (230). Upon application of a voltage, the solid-state device of FIG. 1b includes a layer of a matrix containing electrolyte composition and conjugated polymer (205) disposed between a first electrode (220) and a portion of electrolyte composition (here a gel electrolyte formed by crosslinking the gel electrolyte precursor either before or after the application of voltage) (215); the first electrode (220) and second electrode (230) area in electrical communication with (215) and (205). Further, substrate layers (240) and (250) encase (205), (215), (220), and (230). The generalized device of FIG. 1b can be modified to replace the electroactive monomer with any electroactive precursor discussed herein.

The combination of electrolyte composition and electroactive precursor can be formed into a layer in the device by mixing the components to form a dispersion or solution, and applying the mixture to a substrate via conventional processes including ink jet printing, screen printing, roll to roll printing processes, reel to reel processing, spin coating, meniscus and dip coating, spray coating, brush coating, doctor blade application, curtain casting, drop casting, fill, gasket-fill, syringe-fill, capillary action, and the like. The devices can be prepared by fill and dual lamination of substrates. In one embodiment, the device can be prepared and then cut to a desired size and shape.

In one embodiment, the mixture is spray coating on a desired substrate and the device is assembled as a laminar assembly attached to a second substrate.

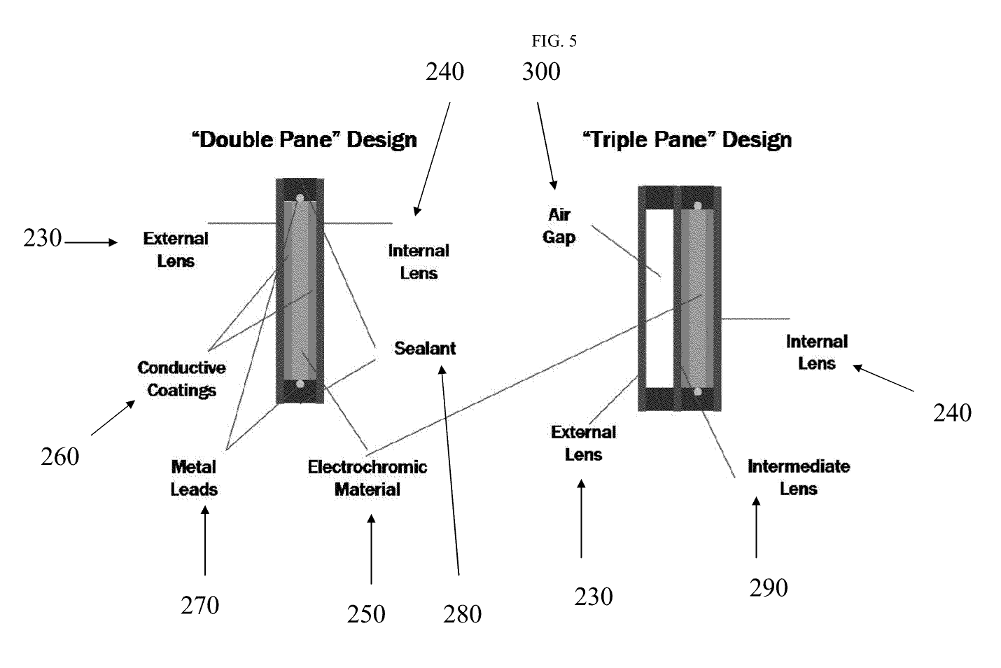

In another embodiment, is a gasket-fill assembly approach to prepare double, triple, or multiple-paned (“n-paned” wherein n is an integer from 2, 3, 4, or more) devices (see e.g., FIG. 5). Within this embodiment, a device chamber is first assembled and then filled with a combination of i) an electrolyte composition and ii) an electroactive precursor. The device is then completed by crosslinking the electrolyte composition, applying a voltage to effect in situ polymerization of the electroactive precursor.

Any desired gasket thickness and fill volume could be used. In one embodiment, the thickness is about 50 micrometers to about 5 millimeters, specifically about 100 micrometers to about 2.5 millimeters. Exemplary volumes can be about 30 microliters to about 30 milliliters of fill solution.

In one embodiment, a gasket is partially filled and then the electrolyte composition is crosslinked, followed by the addition of more of the combination of electrolyte composition and an electroactive precursor and then crosslinking, etc. in multiple steps with the same or different combinations of material to provide for various color-stripes or other type devices to be built.

In another embodiment triple-pane, and “n-pane” windows can be prepared wherein one of the pane chambers is other than a composite of a conjugated polymer and electrolyte composition. Exemplary panes can be used as thermal barriers wherein one of the pane chambers is filled with air, vacuum, or a gas (see, e.g., FIG. 5 “triple-pain” window comprising an air gap).

In another embodiment, gasket-fill assembled devices can be stacked such that the multiple chambers each have different electrochromic materials resulting in separately addressable panes, in series or parallel.

The gasket-fill assembly approach can be used to prepare planar or non-planar (e.g. curved) devices. The non-planar devices can be of any shape. In one embodiment, the device can have one face of the device planar and a second face that is non-planar. Other devices can be doubly curved. Particular applications for use of the approach is in the preparation of non-planar devices such as eyewear, goggles, etc. where the device has a curve or non-flat shape as discussed herein. Mated pairs of lenses with unique shapes can be prepared in order to achieve uniform distance between electrodes across the entirety of the device.

In another embodiment, the electrolyte composition and electroactive precursor assembly approach can be used to prepare devices which form inside of discrete wells on an electrode surface.

In yet another embodiment, the electrochromic device can be premade and then fitted into an existing substrate or another device.

The process disclosed herein to prepare the solid-state device can be used to prepare devices of large surface area, optionally prepared with bus lines. In one embodiment, a device has a surface area of about 8×8 inches. In another embodiment, a device has a surface area of greater than 8×8 inches.

In one embodiment, a device is assembled comprising a combination of a gel electrolyte precursor and an electroactive precursor disposed between a first electrode and a second electrode.

In another embodiment, a device is assembled by disposing a combination of a gel electrolyte precursor and a electroactive precursor on a first electrode, crosslinking the gel electrolyte precursor to form a layer of crosslinked gel electrolyte and electroactive precursor, then adding a second layer of a second gel electrolyte precursor, optionally in combination with a second electroactive precursor, on top of the layer of crosslinked gel electrolyte and electroactive precursor, and assembling a second electrode on the second layer to form a sealed, assembled device. Any number of layers can be used in this fashion. Within this embodiment, the electroactive precursors can be polymerized before or after the crosslinking of the gel electrolyte precursor in the second layer. Such a device may form a dual-conjugated polymer device. Alternatively, precursors with different oxidation potentials may be exploited such that one material polymerizes on one electrode and the second is polymerized on the other electrode, each in situ. For example, two electroactive precursors that are soluble in the gel electrolyte precursor can be used to prepare a dual polymer electrochromic device. Exemplary electroactive precursors having different diffusion coefficients and capable of switching under the same potential window include EDOT and BEDOTNMCz. In this example, BEDOTNMCz would polymerize first as it has a lower polymerization potential, and EDOT will not polymerize. Then EDOT is converted to PEDOT on the other electrode (using +3V) in a 2 electrode system. Both resulting polymers can change color using +/−2 V and they have complementary colors.

In one embodiment, a method of forming a solid-state device comprises filling a gel electrolyte precursor, a first electroactive precursor, and a second electroactive precursor into an enclosed chamber, wherein the first and second electroactive precursor are independently an electroactive monomer, a conducting oligomer, a viologen, a conducting polymer precursor, or a combination thereof, and wherein the first electroactive precursor has a lower polymerization potential than the second electroactive precursor; crosslinking the gel electrolyte precursor to form a combination of a crosslinked gel electrolyte composition comprising the first and second electroactive precursor, wherein the combination is disposed between at least two electrodes, and wherein a potential source is in electrical communication with the at least two electrodes; and applying a first voltage for a period of time (t1) to polymerize the first electroactive precursor to form a composite comprising a first conjugated polymer and crosslinked gel electrolyte composition and subsequently applying a second voltage higher than the first voltage for a period of time (t2) to polymerize the second electroactive precursor to form a composite comprising second conjugated polymer and crosslinked gel electrolyte composition. Such a device comprises the composite at each pole (a dual polymer conjugated in situ device). This is a device archetype that is useful in the mitigation of long-term device stability and function by providing a counter-electrode reaction to compensate for the working-electrode reaction.

The polymerization of the electroactive precursors can be effected by cyclic voltammetry (triangle wave voltammetry), chronocoulometry/constant voltage, galvanostatic/constant current, or square-wave voltammetry (pulsed). In several embodiments, a reference electrode is fabricated inside the device. The potential (voltage) is applied to one electrode of the device for a sufficient time to substantially deplete the electroactive precursor from the combination of electrolyte composition and electroactive precursor. The formation of the conjugated polymer occurs on one electrode side, via diffusion through the electrolyte composition. In one embodiment, the conjugated polymer is not a discrete, thin film layer, as can be formed using electrodeposition methods, but rather is a blend or composite within the electrolyte composition.

In several embodiments, the device comprises an internal reference electrode system to result in a three-electrode cell. In one embodiment, the internal reference electrode is a silver wire pseudo-reference electrode embedded within the device to control voltage and prevent electrode damage (e.g., ITO degradation due to over-oxidation).

Bus lines can be employed in the electrochromic device to enhance switching speeds and to remove iris effects. Bus lines are grids or patterns of conductive lines prepared from highly conductive material (typically metallic, e.g. copper, aluminum, silver, gold, platinum, and steel). Current takes a path of least resistance, and thus the more conductive components (bus lines) will experience current faster/first when compared to other conductors (ITO, PEDOT-PSS, etc). Use of bus lines provides a more uniform current density and thus enhances switching speeds of the electrochromic device. Even fields would allow for much faster switching over a larger area. Bus lines alleviate potential iris effects by distributing the current evenly throughout the surface area, when using a well-defined, close-knit grid. The result is that the distance between any given bus line creates a smaller-area square wherein the iris effect may be present but wholly unnoticeable by the eye (less than 50 μm on an edge, for example).

The use of bus lines can also affect faster/different polymerization kinetics of the electroactive precursor by having a different electric field present inside the device during the “activation” step. Use of bus lines having intentionally uneven or specifically oriented fields could be used as an alternative method for patterning.

Exemplary bus lines can be prepared from metal (e.g. silver) or metallic tape (e.g. copper tape). The size and pattern of the bus lines can be selected to meet the needs of the particular application of the electrochromic device (e.g. eyewear, window, display, etc.). For example, for an electrochromic display, the bus lines can be uniformly spaced to provide a uniform charge distribution through the electrochromic material. An exemplary width size of the bus line is about 0.0025 inch (about 0.0635 mm) at 20 lines per inch (about 8 lines per centimeter) spacing. Each of the bus lines can be in electrical communication with a terminal bus line.

The bus lines can be formed using any one of a number of industrially available procedures, including but not limited to vacuum deposition and ink-jet printing.

In another embodiment, a sealing means (e.g. a gasket) is provided between two substrates or electrodes to form an electrochromic device wherein an internal reference electrode is provided between the sealing means. The sealing means seals the device.

In one embodiment, by controlling the voltage, it may be possible to achieve layered color mixing of various precursors, to form dual-polymer devices with different polymer composites being formed on alternate electrodes, and to form complex gradient blends and copolymers. Varying the voltage, time of application, and/or method of polymerization, one may achieve these architectures.

In yet another embodiment, a method comprises polymerizing a first electroactive precursor on a first electrode using a first potential and then polymerizing a second electroactive precursor at a second electrode at a second potential different than the first potential. Such a process may create a dual-conjugated polymer device. Precursors with different oxidation potentials may be exploited such that one material polymerizes on one electrode at one applied voltage and the second is polymerized on the other electrode at another applied voltage, each in situ.

Dual-polymer electrochromics (that is, anodically and cathodically coloring materials that undergo color changes which are complimentary to one another) can be prepared using the in situ process. The dual-polymer electrochromic enhances the lifetime of the electrochromic device by having counter-electrode reactions minimized and balanced and prevents the overall degradation of components within the device. The term “ion storage layer” may refer to the second conjugated polymer in question for “dual-polymer” devices.

Dual-polymer electrochromics can be prepared using the in situ method to prepare one or both of the conjugated polymers. In the embodiments where only one conjugated polymer is prepared via the in situ method, the second conjugated polymer can be prepared using traditional electrochemical deposition.

Another exemplary process to prepare a dual-polymer electrochromic includes the use of soluble precursor polymers applied to the counter electrode which are then converted to their conjugated form (either chemically or electrochemically) can serve as the second conjugated polymer. Once formed, device assembly proceeds, and the in situ process applied to form the first conjugated polymer.

In another exemplary process to prepare a dual-polymer electrochromic includes use of ion storage layers that take the form of soluble or dispersed conducting polymers that are applied to the counter electrode prior to the in situ fabrication procedure.

In still another process to prepare a dual-polymer electrochromic, the in situ method may be used to achieve polymers at both electrodes, provided the polymerization voltage of each is tuned appropriately. Thus, a fully in situ device would polymerize an anodically (or cathodically) coloring electroactive precursor at one voltage on one electrode and subsequently a cathodically (or anodically) coloring electroactive precursor would be applied at another voltage on the opposite electrode.

Dual-precursors will be applied and converted to form both sets of polymers for the dual-type device. Each conductive substrate will be coated with a precursor polymer, one anodically coloring and one cathodically coloring. The device can then be assembled and via applied voltages to each electrode, precursors will convert to conjugated polymer.

The devices can be sealed to prevent water, air, or other contaminant materials from entering the device, as well as to prevent loss of electrolyte composition/electroactive precursor or electrolyte composition/conjugated polymer. Sealing can be accomplished using an adhesive such as a polyurethane based UV curable resin or other suitable adhesive used in the formation of electrochromic devices.

Exemplary adhesives for use to seal the device include a silicone rubber, a UV-cured adhesive, a heat cured adhesive, an epoxy resin adhesive, or any number of other adhesives. The adhesive can be selected such that it is compatible with (i.e. will not react or be dissolved by) the other components of the device, such as the gel electrolyte precursor mixture, electroactive precursor, crosslinked gel electrolyte composition comprising the electroactive precursor, and the like. An exemplary adhesive can be epoxy resin (CAS No. 25068-38-6) mixed with an amine curing agent (CAS Nos. benzyl alcohol 100-51-6, diethylenetriamine 111-40-0, 1,6-hexylenediamine 124-09-4, 1,2-diaminocyclohexane 694-83-7,2,4,6-tris(dimethylaminomethyl)phenol 90-72-2) at a ratio of about 100:30 epoxy:amine. The epoxy resin can be cured with heat (e.g. 3 hours at 60° C.) or allowed to cure at room temperature over 24 hours.

When sealed, the devices do not require rigorous clean room conditions or other extreme-cleanliness procedures as the device is hermetically sealed prior to the formation of the electrochromic. Furthermore, there is no special need for vacuum conditions, specific humidity level, and the like. The substrates do not require specific and rigorous cleaning steps, unlike in electrochemical deposition processes.

In yet another embodiment, a “laminate to” approach to assembly device is used. Within this embodiment, a complete electrochromic device is prepared and then attached to an existing substrate. The substrate may be inherently conductive.

The devices can be patterned using a variety of techniques including using a blocking (aka “insulating”) layer of material (e.g. blocking material applied by ink jet printing, spray-cast, etc.), drop-cast patterning, directed polymerization by the selective application of voltage, direct patterning, lithography, patterned electrode surfaces, and other related methods to result in the formation of complex electrochromic devices. High-resolution images can be created using the patterning. The entire region of the device can be patterned or alternatively, only a portion of the device. In one embodiment, the pattern generated may be in the form of a straight line, a curved line, a dot, a plane, or any other desirable geometrical shape. The pattern may be one dimensional, two dimensional or three dimensional if desired and may be formed upon the surface of the combination of electrolyte composition and conjugated polymer mixture as an embossed structure or embedded within (below) the surface of the combination.

The devices can be patterned using a blocking layer of material, such as a material that is insoluble in the electrolyte composition. Exemplary blocking materials include polystyrene, etc. The blocking material can be applied to the working electrode using spray-casting, drop-casting, ink jet, screen printing, roll to roll printing processes, reel to reel processing, spin coating, meniscus and dip coating, brush coating, doctor blade application, curtain casting, and the like. This layer now blocks the electrical field produced within the device upon application of voltage, which results in no polymer forming in these areas. The device, when in situ polymerized, will then be patterned around the blocking layer. When the device is switched, the blocking layer will remain constant as the electrochromic changes color around it. The blocking layer may be loaded with a dye, such that in one state, the electrochromic is the same color as the blocking layer but in another state it is not (or is always a different color), thus allowing for the patterned image/lettering/numbering/etc to be reversibly “revealed” and “concealed” upon switching.

In the patterning process using selective application of voltage, an electrochemical atomic force microscope (AFM) tip can be used as an external counter electrode to supply the voltage. In an alternative embodiment, injection polymerization can be accomplished using a needle to supply both a voltage and the combination of an electroactive precursor and electrolyte composition.

In one embodiment, a nanolithographic pattern may be generated by utilizing electrochemical atomic force microscopy (AFM) to selectively polymerize the electroactive precursor. In this method, an AFM tip (coated with a conductor such as gold, platinum/iridium, carbon, optionally modified with carbon nanotubes) is used as a counter electrode. The AFM tip is either brought into contact with the combination of electrolyte composition and electroactive precursor or brought into the proximity of the combination of electrolyte composition and electroactive precursor without touching the combination, and a suitable voltage is applied between the electrochemical AFM tip and the substrate, which promotes polymerization of the electroactive precursor contacted by (or brought in close proximity to) the AFM tip.

In one embodiment, the device can be prepared with individually addressable electrode systems, thus allowing for pixilation of a device. Such devices are useful for simple display applications.

The devices can comprise a potential source in electrical connection with the electrodes. Any power source can be used that is capable of delivering a level of power necessary to power the device. The power consumption and duration of such a device is much lower than LCD or LED devices which require constant power. For example, a watch battery (+/−3V) is sufficient to switch the electrochromic in eyewear for several months. Furthermore, unlike SPD, LED, and LCD systems, the device will not, unless specifically designed to do so, “fail-to-dark” when the power is lost or the battery fails, etc.

Exemplary sources of power include watch batteries, button batteries, traditional batteries, a capacitor, a solar cell/photovoltaics (organic, inorganic, or hybrid), or electrical grid. In one embodiment, the power source for a device is a combination of a battery and a photovoltaic.

The power supply can be a discrete on/off, have discrete intermediate states at a set voltage/current ranges, or can be analog using a dial or slider mechanism.

The electrochromic device has a memory when power is turned off. In one embodiment, the device can be designed to switch to a certain color when the power is turned off or the power fails, or some other fail state. Use of a fail-safe capacitor or other control circuitry can be used to sense the failure and send a pulse of power (charge/current/voltage according to the power requirements by electrochromic device area) to switch the device to the fail-safe mode. The fail-safe capacitor is a separate source of power from the main source and which contains a pulse of power sufficient to switch the device one last time. In an exemplary embodiment, the device is eyewear and the fail-safe mode is “fail-to-clear” to ensure visibility. In other embodiments, such as welding goggles or other safety applications, the fail-safe mode can be “fail-to-dark” to prevent blinding events.

The switching in the fail-safe mode can be achieved with an automatic trigger based on light, temperature, pressure, or other physical, chemical, or electrical stimulus by use of a sensing element. The sensing element will determine the “failure” conditions and upon input of a failure condition, the original power source contact would be severed and the fail-safe circuit would activate, causing the final switch to the desired state of clear or dark. The fail-safe feature can use a separate circuit connected to the electrochomic device that is not part of the normal power supply. The power source for the fail safe electronic components can be any of those previously described including batteries or a solar cell.

The electrochromic devices are capable of displaying a still or animated color image composed of a combination of red, green, and blue visible light. Displaying occurs typically by reflection or transmission of visible light rather than by emission when the electrochromic material is subjected to an electrical potential.

In one embodiment, the device is a reflective-type device (e.g., [Mirrored] aluminum or steel background/PET-ITO counter).

Typically, when each electrode comprises the same electrochromic material, the electrodes display different colors simultaneously, due to the electrochromic material undergoing oxidation at the cathode and reduction at the anode, a so-called “dual electrochromic” design.

In one embodiment, the solid-state device comprises a single composite layer of the conjugated polymer and electrolyte composition.

In another embodiment, the solid-state device comprises a dual-type configuration wherein there is a second composite layer of conjugated polymer on the counter electrode. The second layer can be a composite of a second conjugated polymer and second electrolyte composition. The use of two conjugated polymer layers allows for mixed colored states or enhanced contrast by using conjugated polymers with complementary optical characteristics. Within this embodiment, an electroactive precursor which produces an anodically coloring polymer and an electroactive precursor which produces a cathodically coloring polymer can be used in the dual-type configuration. Exemplary dual-type configurations are disclosed in U.S. Patent Publ. 2007/0008603 to Sotzing et al.

In another embodiment, a multi-layered device is prepared comprising a second layer wherein the second layer is a second composite layer of conjugated polymer on the counter electrode, an ion storage layer, or other protective layer on the counter electrode, with respect to the working electrode and primary electrochromic composite layer. The second layer can be prepared via the in situ method described herein, or prepared by other methods (e.g. spray coating, spin casting, precursor polymer conversion, electrospinning, and the like). Within this embodiment, the separate layers may be prepared and assembled together prior to applying a voltage to polymerize the electroactive precursor. Upon final multi-layer device assembly, then a voltage is applied to effect polymerization. In another embodiment, the separate layers are prepared, then a voltage is applied to effect polymerization, and subsequently the different layers are assembled into a multi-layered device.

In one embodiment, the absorptive/transmissive electrochromic device comprises a “smart” switch to switch the electrochromic materials between colored and bleached (colorless) states. The automatic trigger may be based on light, temperature, pressure, or other stimulus. In one embodiment, when the electrochromic device is exposed to sunlight, a photo-switch in the device causes the electrochromic material to transition to the colored state, thereby darkening the device.

The process disclosed herein can be used to prepare solid-state devices such as electrochromic devices that are entirely transparent or translucent or that are partially transparent or reflective. Exemplary devices include organic thin-film transistors, organic light-emitting diodes, organic photovoltaic cells, and the like. Specific articles prepared from the devices include eyewear such as color-changing sunglasses, high-contrast sunglasses or goggles, windows devised for heat-modulation in skyscrapers/buildings or fashion-tinting, auto-dimming mirrors in automobiles and trucks, rear-view mirror, displays including see through displays, or a variety of others.

### Eyewear

The solid-state devices described herein are particularly suited for eyewear, including sunglasses, goggles, including safety goggles, etc. As used herein, “eyewear” or “eyewear device” will be used generally to include, unless otherwise indicated, all forms of eyewear including sunglasses, ski and sporting goggles, military eyewear (ballistic goggles and ballistic sunglasses), face shields, motorcycle and sports helmets with visors, shade visors, eye protection (lab goggles, safety goggles, safety glasses), welding helmets and facemasks, and the like.

The eyewear device may comprise an electrochromic device having both a transmissive and reflective component. Such devices can project an image such that the electrochromic, via action of switching can regulate the reflectivity of the image to the viewer and change the level of transmission the viewer can see through the image. These devices may be simple, smart-window type eyewear devices or they may comprise patterned surfaces for logos or for complex display applications, or both.

The conductor or electrode materials for use to prepare electrochromic eyewear can include those previously discussed above. Exemplary electrode materials for use in the eyewear electrochromic devices can include inorganic materials such as indium doped tin oxide (ITO) coated substrates (e.g. glass, poly(ethylene terephthalate [PET], and the like); doped silicon; thin metallic grids prepared from copper, steel, gold, silver, platinum, aluminum, and the like; organic materials such as a conjugated polymer such as poly(3,4-ethylenedioxythiophene)-polystyrene sulfonate (PEDOT-PSS), conjugated polymers prepared from an electroactive monomer described herein; and carbon black, carbon nanotubes, graphene, and the like. Reflective devices could be made of mirrored steel or mirrored silver, various forms of metallic meshes, or other forms of organic/inorganic materials or hybrid materials, and the like.

Exemplary substrates for use to prepare electrochromic eyewear lenses include those previously discussed above. The substrate can be flexible or rigid, planar or non-planar (curved). Exemplary substrate materials include glass, plastic, and the like, as well as a combination thereof. Flexible substrate layers can be made from plastic. Exemplary plastics include polyethylene terephthalate (PET), poly(arylene ether), polyamide, polyether amide, polycarbonate (ballistic and non-ballistic), poly(ethylene naphthalate) or PEN, poly(imides) such as KAPTON or other transparent polyimides such as those developed by Akron Polymer Systems, Inc., and acrylates or acrylics, and the like.

Doubly curved (spherical) substrates may be used in the fabrication of various goggles and face shields, as well as the more traditional singly curved (cylindrical) or flat (planar) substrates. There is no specific limitation to the angle or degree of curvature of the lenses, provided that equal distance within a practical tolerance is maintained between the two conductive substrates. The tolerance can be less than about 10% thickness, specifically less than about 7.5% thickness, and more specifically less than 5% thickness variation. The distance between the two conductive substrates can be selected based on the desired eyewear application. The distance between the two conductive substrates can be about 1 micrometer to about 5 millimeter thick, specifically about 100 micrometers to about 1 millimeter, and more specifically about 200 micrometers to about 0.5 millimeter. A substantially equal distance between the substrates will ensure no optical distortion occurs due to refractive index changes. Further, equal distance ensures optical quality in terms of even coloration and switching for the electrochromic.

Curvature will only be limited by the mechanical stresses on the substrate and the performance of the conductive coating (ITO, graphene, nanotube, conducting polymer, etc.) under those conditions. Thus, “base/cap” or “male/female” may refer to interior and exterior lenses which are appropriately mated for such distance requirements. Pre-curved substrates can be prepared or a flat electrochromic device can be prepared and then form-fitted to another surface or molded to a curved surface.

In several embodiments, the substrate can be ballistic. The ballistic substrate can be prepared from polycarbonate. In one embodiment, the eyewear comprises two ballistic substrates. In another embodiment, the eyewear comprises a single ballistic substrate with a counter substrate that is non-ballistic. These may be interior or exterior lenses, depending on individual choice, and no limitation is implied on the configuration of the lenses, whether double or triple paned.

The substrate for preparing the eyewear electrochromic device can be a polarized substrate. The use of a polarized substrate may darken the overall contrast value of the device by shifting the amount of total transmitted light to a lower value.

In one embodiment, the eyewear electrochromic device further comprises a polarized lens, distinct from the polymerized substrate discussed above.

The eyewear can further include one or more additional layers or coatings including, for example, hard coat, anti-fog coat, anti-reflective coat, anti-scratch coat, polarizing coatings, and the like. When one or more of additional layers is present in the eyewear device, there is no limitation to the location of the layer as long as the conductor layer is positioned to provide an electrochemical cell, typically as the top-most layer.

The additional layer may be in the form of a coating applied to the internal or external surface of the eyewear lens. Various processes can be used to prepare the additional layer including, for example, dip-coating to coat both sides of a lens, flow-coating to coat one or more sides, and the like.

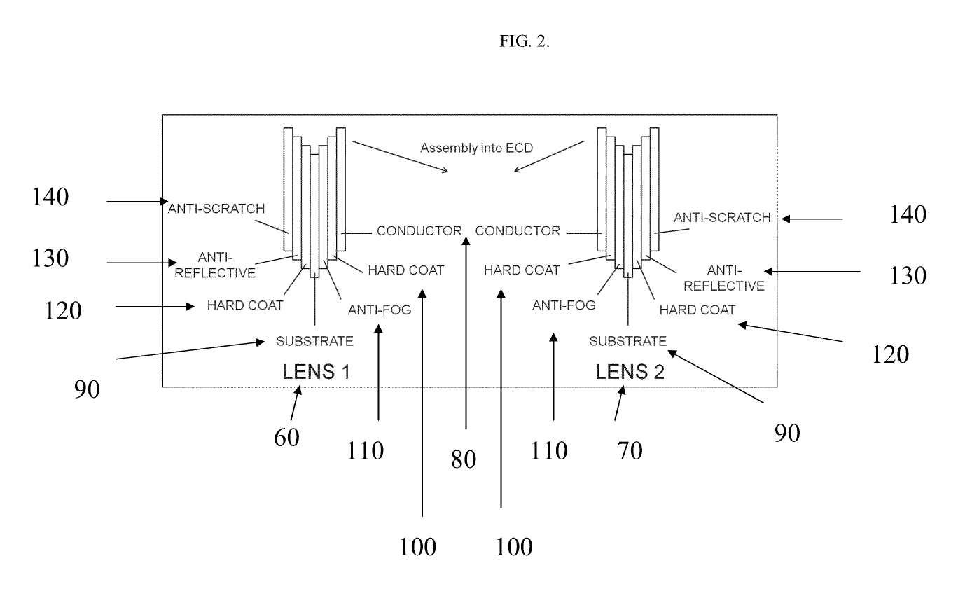

FIG. 2 illustrates an exemplary schematic of coated substrates for use to prepare an eyewear electrochromic device. The figure is exemplary only and does not limit the numerous permutations of coating types, coating order, and lens shapes which can be used. To ensure electrochromic function, the lenses comprise a substrate (90) and a conductor (80) that will be present on the interior of the electrochromic device once assembled with the two lenses. The additional layers can optionally be present on one or both of the lenses, either interior or exterior, as long as and electrochemical cell can be formed. The number, order, and specific location of each of the additional layers are not intended to be limiting as long as an electrochromic device can be formed. Lens 1 (60) and Lens 2 (70) are shown to be mirror images of one another comprising an interior hard coat (100), and exterior hard coat (120), an anti-fog coat (110), an anti-reflective coat (130), and an anti-scratch coat (140). In other embodiments, the two lenses are differently coated while in other embodiments the two lenses are identically coated. In FIG. 2, the rear and front lenses are interchangeable for any device architecture

The substrate may comprise a hard coat to provide chemical resistance and resistance to abrasives. Exemplary hard coat materials include melamine-, acrylic-, and urethane-based materials, a siloxane or organosiloxane material optionally in combination with a metal alkoxide, silicone, silicon oxynitride, and the like.

Exemplary anti-scratch coat to provide abrasive and physical resistance include the hard coats discussed above.

Exemplary anti-fog coat materials include a siloxane or organosiloxane material optionally in combination with a metal alkoxide.

Exemplary anti-reflective coat, materials include a siloxane or organosiloxane material optionally in combination with a metal alkoxide.

In processes to prepare eyewear, the gel electrolyte precursor can be converted to a gel via radical crosslinking initiated by thermal methods, or in particular by exposure to ultraviolet (UV) radiation as discussed above. The choice of crosslinking approach can be based on device constraints. For example, device preparation using substrates with UV-blocking coating, use of UV blocking dyes, or ballistic substrates which are incapable of allowing UV-penetration at 365 nm sufficient to cause crosslinking of the gel electrolyte can employ thermal curing instead of UV radiation. Thermal curing and UV curing are as previously described above.

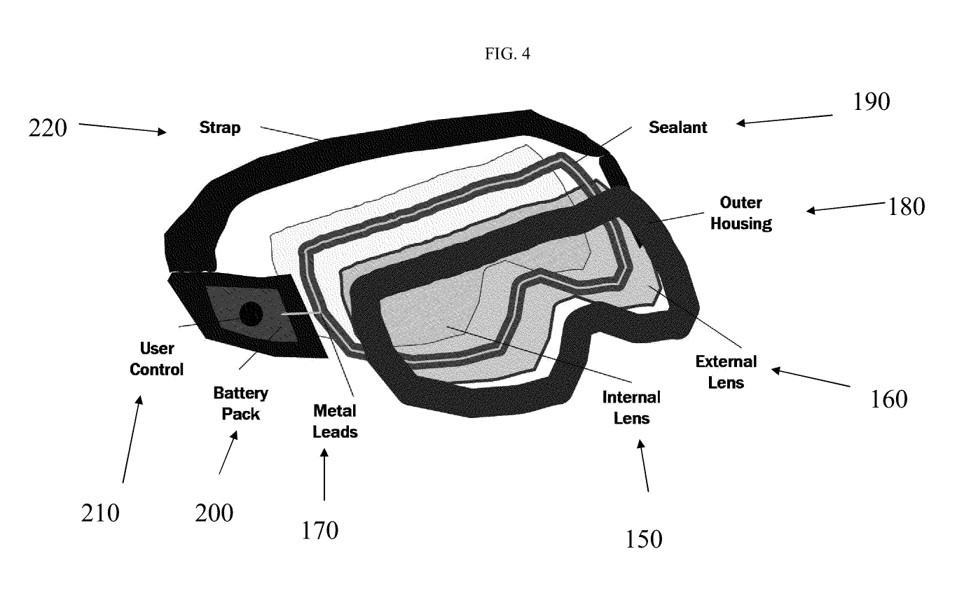

The eyewear device further comprises a lead in electrical communication between the power supply and the at least two electrodes of the electrochromic device. In exemplary embodiment, a lead can be located around the perimeter of the electrochromic device substrate (see FIG. 4, metallic lead (170)). Exemplary materials that can be used for the metallic lead include copper, silver, gold, aluminum, platinum, titanium, carbon paste, steel, and the like. In one embodiment, the lead is made from adhesive copper tape. The lead can be in any number of configurations, for example strip, line, spot-point connections, tabs, and the like, and can be asymmetrical or symmetrical. The leads can be applied to the device using known processes including ink-jetting, contact printing, evaporation, sputtering, plasma etching, damascene, and the like.

The eyewear device further comprises a power (potential, voltage) source in electrical communication with the electrodes capable of delivering an amount of power, voltage, and current to the device to effect switching. Power usage for eyewear electrochromic devices can be about 1.00 mW/cm² to about 2.00 mW/cm², specifically about 1.50 mW/cm² to about 1.75 mW/cm². Any battery or power source (including but not limited to 3V watch batteries, button batteries, traditional batteries, rechargeable, solar-powered, solar-recharged capacitor, a capacitor, a solar cell/photovoltaics (organic, inorganic, or hybrid), or electrical grid, and the like) capable of delivering the required amount of power, voltage, and current to the device can be used. The power consumption and duration of such a device is much lower than LCD or LED devices which require constant power. For example, a watch battery (+/−3V) is sufficient to switch the electrochromic in eyewear for several months. In one embodiment, the power source for a device is a combination of a battery and a photovoltaic.

The eyewear device can further comprise a variable-transistor to modulate voltage across a continuum.

The eyewear device can further comprise a switching control in electrical communication with the power source and the electrodes. The switching control can be simple to perform only at extreme states (on/off or light/dark), for example built from the power source and applying only +3V or −3V. The switching control can be a variable resistor type electronic (for example, dial, knob, or other tunable device) to allow for user-controlled continuum of color changes at any point between +/−3V. In another embodiment, discrete states may be built such that specified intervals of voltage/current are used instead of a full continuum (for example 3, 2, 1, 0, −1, −2, and −3 V settings). In one embodiment, switching will occur at +/−1.5V, with respect to an appropriate reference electrode.

There is a current spike concomitant with the voltage pulse that is required only for a short time in order to achieve the appropriate redox chemistry within the electrochromic device (as measured by an UV curve, each with respect to time, with a potentiostat; the exact nature of the spike will vary slightly from device to device based on device area, conjugated polymers, and electrolyte matrices). A power supply is selected for the eyewear so that the amount of current for the amount of time for a particular device will be generated. In one embodiment, any power source of sufficient voltage (with the capacity to generate greater than or equal to 1.5V), current, and power density may be employed to power the solid-state eyewear device.

The electrochromic device has a memory when power is turned off Unlike SPD, LED, and LCD systems, the device will not, unless specifically designed to do so, “fail-to-clear” when the power is lost or the battery fails, etc. In one embodiment, the device can be designed with a specifically designed controller to switch to a certain color when the power is turned off or the power fails, or some other fail state (e.g. battery life warning, lens cracking, etc). Use of a fail-safe capacitor or other control circuitry can be used to sense the failure and send a pulse of power (charge/current/voltage according to the power requirements by electrochromic device area) to switch the device to the fail-safe mode. The fail-safe capacitor is a separate source of power from the main source and which contains a pulse of power sufficient to switch the device on last time. In an exemplary embodiment, the device is eyewear and the fail-safe mode is “fail-to-clear” to ensure visibility. In other embodiments, such as welding goggles or other safety applications, the fail-safe mode can be “fail-to-dark” to prevent blinding events.

The switching in the fail-safe mode can be achieved with an automatic trigger based on light, temperature, pressure, or other physical, chemical, or electrical stimulus by use of a fail-safe sensor element. The fail-safe sensor element will determine the “failure” conditions and upon input of a failure condition, the original power source contact would be severed and the fail-safe circuit would activate, causing the final switch to the desired state of clear or dark. The fail-safe feature can use a separate circuit connected to the electrochromic device that is not part of the normal power supply. The power source for the fail safe electronic components can be any of those previously described including batteries or a solar cell.

The eyewear device may be prepared using any of the electroactive precursors as discussed above. The choice of starting material may be made with regard to the color transition of the electrochromic desired. Exemplary electroactive precursors include electroactive monomers EDOT, PropOT-Me₂, and pyrrole. The colors of the color transition can be characterized according to the CIE color coordinate diagrams.

Color mixing can be achieved via chromophore mixtures, co-polymerizations of different electroactive precursors, and the like; use of neutral filters, dyes (either included within the lens matrix, the electrolyte matrix, or applied as a coating, or a combination thereof), use of dual-polymer electrochromic devices, and use of stacked electrochromic devices (i.e. two or more electrochromic devices on top of one another, each separately controlled for their switching states).

In several embodiments, the eyewear is a goggle including, but not limited to, military, ski, sport, safety, and the like.

In one embodiment, the eyewear is a military-type goggle providing ballistic face protection in addition to light modulation or attenuation for rapid changes in environment (indoor/outdoor with automated sensor, user controlled sunglass-type effects, flash bang auto-darken protection, focus for hazy, foggy, or cloudy environments, other field-of-view contrast enhancements, and the like).

Current technology for military-type goggles has the wearer physically removing the lenses and changing in the sunglass (or clear) depending on environment. This is a highly inefficient and potentially life-threatening limitation that is easily addressable with the electrochromic eyewear. Desired color transitions for military-type goggles include but are not limited to grey/black/brown states to clear states. Yellows, reds, and other colorations each also have specific applications that can be targeted.

Ski or sport goggles can be designed to provide adaptive sunglass effects on the face protection. Color transitions can be effected to handle glare from snow, falling snow and rain, fog, and the like without having to change out separately-colored filters that must be replaced by the wearer in traditional goggles. Desired color transitions for sport-type goggles include but are not limited to grey/black/brown (colors found in standard sunglasses) as well as oranges, yellows, and reds (for fog, mist, and haze reduction for various sporting applications, including but not limited to skiing, hunting, paintball, etc).

In one embodiment to prepare an electrochromic goggle involves the formation of the electrochromic device via the in situ process before-hand and a subsequent fitting-onto (or laminating onto) existing lenses. The in situ lens may be formed via roll-to-roll lamination, ink-jet processes, doctor blading, screen printing, spray coating, and any number of other industrially known methods. Thus, a very thin electrochromic device could be assembled and form-fitted onto the surface of the desired lens, either on the interior or exterior. This approach can be used for any and all devices described herein besides the formation of goggles.

In another embodiment, a gasket-filling process may also be employed. In the gasket-filling process, i) two conductive substrates of the desired shape, size, and curvature are assembled together (with the conductor-sides facing inward), with a given distance air gap between them, using a sealant of some kind; ii) a syringe, nozzle, or other similar device either punctures the seal (e.g. in the case of silicone rubber sealants) or fits into a defined gap in the seal and delivers a gel electrolyte precursor and an electroactive precursor to fill the air gap, with an appropriate outlet for the air within to escape; iii) optionally the seal is reinforced or completed; and iv) crosslinking the gel electrolyte precursor to form a combination of a crosslinked gel electrolyte composition comprising the electroactive precursor; v) applying a voltage to polymerize the electroactive precursor to form a composite comprising conjugated polymer and crosslinked gel electrolyte composition. The delivery of the gel electrolyte precursor and an electroactive precursor to fill the void can be achieved by injection or via capillary action (wicking in of fluid). Delivery by capillary action can be accomplished in a variety of ways, among them dripping fluid onto the open side via pipette, syringe, syringe pump, and the like. Capillary action fills the void and air is expunged from the chamber until the chamber is entirely filled. The distance of the gap in step i) may be from about 1 micrometer to about 5 millimeter thick, specifically about 100 micrometers to about 1 millimeter, and more specifically about 200 micrometers to about 0.5 millimeter. The sealant of step i) could be a silicone rubber, a UV-cured adhesive, an epoxy adhesive, or any number of other sealant glues and materials.

Once the electrochromic device is assembled, it, in one embodiment, can then be fitted onto an existing ballistic (or otherwise) goggle frame. Electrical connections housed on the frame and strap would allow for contact and user control of the final device. An example of a device built in this manner appears in FIG. 4. The goggles include internal (150) and external (160) lenses encased in an outer housing (180) and sealed with a sealant (190). Metal leads (170) are provided around the edge of the goggles and connected to a battery pack (200) and user controls (210) located on a strap (220).

The substrate for the goggles will be in the form of conductive substrates. Exemplary conductive substrates include, for example, ballistic polycarbonate, a polarized lens, or a specially coated plastic can be coated with ITO or some other conductor. The first lens is a functional lens due to a special coating, ballistic property, etc. A second lens, also coated with ITO or some other conductor, is used to complete the electrochromic device structure. The second lens could also be functional and have other, separate coatings, or it may simply be a rear lens which is thin and transparent so as not to affect any optical clarity of the device.

The goggles can be prepared with double-pane or triple-pane structures. FIG. 5 shows a side-view schematic for each of these types of devices. “Double pane” refers to an electrochromic device architecture where each pane is a conductive substrate. The structure includes an internal (240) and an external (230) lens, conductive coatings (260) on the lenses, an electrochromic material (250) disposed between the lenses, metal leads (270) and a sealant (280). “Triple pane” refers to an additional substrate layer sealed to the double-pane, with a gap that contains air, a vacuum, an inert gas, and the like, or other fills, either in front or in back. Air gaps, such as those in the FIG. 5, are used as anti-fog and thermal barriers for eyewear and also for windows.

In another embodiment is a goggle containing a specialty substrate (e.g. containing ballistic lens, anti-fog coating, hard coat, and the like) and an external assembly of the electrochromic device. The specialty substrate lens may form a major portion of the goggle. Any or all specialty coatings and goggle-related components can be contained within this external or internal lens. The second conductive substrate would then be laminated (either roll-to-roll or via some other process already discussed) onto the specialty substrate. This would allow for the second substrate, whether rear or front, to be made of a thinner, separate material and can be easily formed and swapped for other materials without any detriment to the optics of the goggle.

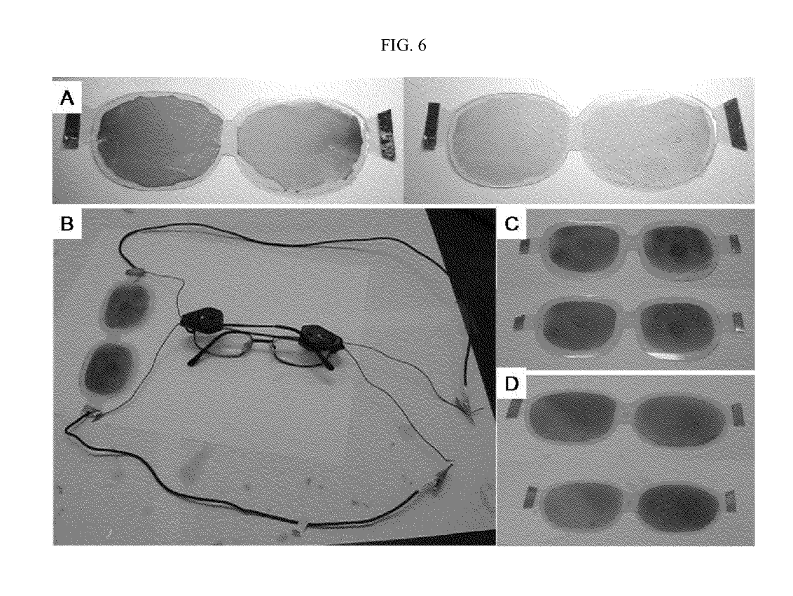

In several embodiments, the eyewear is electrochromic sunglasses. The electrochromic sunglasses are a significant improvement over the current photochromic technology in several ways, namely user control, color options, instantaneous switching, lack of “indoor” effects and cost of manufacture and materials. FIG. 6 shows several different sunglass prototypes built using PET-ITO substrates that were cut from a larger roll in a cookie-cutter fashion. The eyepieces were measured to fit various existing eyeglass frames. These exemplary devices use a single eyepiece for both eye lenses, although it should be understood that separate electrochromic devices may be assembled and controlled separately and/or cooperatively for each eye, individually, as well.

FIG. 6A shows a device prepared using the in situ monomer approach, wherein the electrolyte/electroactive precursor solution was applied onto one substrate, the two lenses were sealed using a UV-adhesive, the electrolyte was UV cured to form a crosslinked gel electrolyte, and the device was activated and switched by the application of an appropriate voltage. The copper leads for this particular device are only at the extreme edges, which was sufficient to cause the entire device to switch in a reasonable time frame (less than 1 second). The electrochromic material in FIG. 6A is in the neutral state at left and oxidized state at right.

FIG. 6B shows a prototype assembly of electrochromic device sunglasses including frame and power supply as a frame-side battery. The wiring was left exposed and not hidden, although any real product would of course have fully integrated and aesthetic considerations. In several embodiments, the frames will house the battery/power supply, as well as the method of control (button, switch, etc.) for activating and deactivating the electrochromic device and for normal operation of the device. FIG. 6C shows overhead views of the device in FIG. 6B in each of its colored states (top=oxidized, bottom=neutral).

FIG. 6D shows a prototypical red/blue “3D glasses” type sunglasses device. The device was assembled such that while one eye-portion of the electrochromic device is in the oxidized state, the other eye-portion is in the neutral state. When the device is switched, the polarity of the 3D lens is switched. There would thus be a small optical effect observed if the wearer were viewing a 3D image.

Exemplary assembly methods to prepare the sunglasses include a modified gasket-fill procedure (similar to the goggles, described above) wherein the hard sunglass lens is coated with conductor and assembled with a gap between itself and a rear conductive substrate. A filling apparatus would then fill in the gap with a gel electrolyte precursor and an electroactive precursor. The electrolyte can then be cured and the device can then be activated and switched. Another method of manufacture would involve taking the hard sunglass lens, coated with conductor, and laminating the rear conductive substrate onto it over an existing coat comprising a gel electrolyte precursor and an electroactive precursor. In this case, the a gel electrolyte precursor and an electroactive precursor would either be spray-cast or specifically formulated for higher viscosities such that it could be applied in a paste-like manner prior to the rear lens being laminated.

In several embodiments, the eyewear is electrochromic safety eyewear such as welding safety eyewear including welding helmet face shields or visors, laser safety eyewear including laser-protection goggles and glasses, “shields” and safety equipment including police/etc. helmets, riot shields, and similar personal protective equipment, and the like. Current technology in use for welding helmets includes simple hinged face-shields and visors which are manually flipped up and down when welding begins and ends. There has also been some developments with LCD screens, coupled to photosensors, which darken instantly (less than 1 ms) when welding light triggers a switch. These screens require constant power, suffer from being small area (3″×5″ or similar sizes), and are inflexible. The LCD devices are also assembled using mainly glass substrates and are heavy relative to manually-operated helmets. The small area translates into a small viewing window, as well, and peripheral vision suffers as a result. Current laser-safety eyewear is not responsive or automatic, but relies on specific goggles or glasses to be worn by the user.

The use of electrochromic devices as described only requires low-power, and can be designed to be flexible and include a large viewing area. In one embodiment, electrochromic devices replace the existing LCD devices in welding helmet face shields thereby solving both the power and weight concerns. Another embodiment calls for curved visors or larger-area (for example, 6″×6″ or 12″×3″) flat visors, which allow full peripheral vision to be restored to the user. Such devices can be assembled via any of the aforementioned manufacturing processes. Assembly into the helmet-architecture (in terms of aesthetic and in term of power supply and operational control) is similar in nature to the goggle systems described above.

For laser-safety eyewear, electrochromic device goggles and glasses can be assembled with photosensors that trigger the darkening when laser light hits them, offering instant protection in the event of an unexpected laser discharge.

The electrochromic safety eyewear is designed to conform to various ANSI and OSHA standards for personal protective equipment (PPE) used in eyewear safety. For example, welding eyewear is designed to have a specified dark shades (e.g. ANSI 287.1-2010 and others).

Switching times for the electrochromic safety eyewear can be less than 1 ms. The use of metal bus lines as described above can be employed in order to enhance switching speeds to below the 1 ms threshold. The bus lines are thin (less than 180 micrometers, specifically about 20 microns in width) so as to be invisible to the naked eye at normal distances (such as those inside a welding helmet or on laser safety equipment).

Specifically for laser-safety eyewear, the electrochromic material will not be simply a neutral grey (or brown or black etc) color, as for goggle, sunglass, and welding-type applications. It will be engineered via various color chemistries (including monomer mixing and co-polymerizations, neutral filters, synthetic monomer and polymer design, and combinations thereof) in order to match the wavelength of the laser in question (665 nm, etc). The absorbance of the specific wavelength of the laser will have to be tuned via these chemistries, and the intensity of the absorbance at that given wavelength will also be maximized to afford compliance with the ANSI and OSHA standards for laser-safety eyewear (ANSI Z87.1-2010 and others).

### Display

The solid-state devices described herein are particularly suited for display applications. Exemplary display applications include eReaders, televisions, cell phones, see-through displays, kitchen-type displays, dials of all shapes and sizes, street signs, wall/building signs, artistic frames (photo-frames, frames that change color themselves, posters and other wall-mounted displays that change images), billboards and other advertising, and the like.

Devices intended for use as displays do not necessarily require a back-light and can make use of ambient lighting. Instantaneous switching is achievable irrespective of the device location. Furthermore, the device does not suffer from the time delay or “indoor” effect that photochromics suffer from (UV light blocked by house windows or by car windows, causing even slower functionality of the photochromic).

Exemplary electrode materials for use in the display electrochromic devices can include those materials discussed previously including inorganic materials such as indium doped tin oxide (ITO) coated substrates (e.g. glass, poly(ethylene terephthalate [PET], and the like); titanium dioxide; doped silicon; thin metallic grids prepared from copper, steel, gold, silver, platinum, aluminum, and the like; organic materials such as a conjugated polymer such as poly(3,4-ethylenedioxythiophene)-polystyrene sulfonate (PEDOT-PSS), conjugated polymers prepared from an electroactive monomer described herein; and carbon black, carbon nanotubes, graphene, and the like. Reflective devices could be made of mirrored steel or mirrored silver, various forms of metallic meshes, or other forms of organic/inorganic materials or hybrid materials, and the like.

The display device may be prepared using any of the electroactive precursors as discussed above. The choice of starting material may be made with regard to the color transition of the electrochromic desired. The colors of the color transition can be characterized according to the CIE color coordinate diagrams.

Color mixing can be achieved via chromophore mixtures, co-polymerizations of different electroactive precursors, use of neutral filters, dyes (either included within the lens matrix, the electrolyte matrix, or applied as a coating, or a combination thereof), use of dual-polymer electrochromic devices, and use of stacked electrochromic devices (i.e. two or more electrochromic devices on top of one another, each separately controlled for their switching states).

### Patterning and Patterned Devices

Patterned devices such as signage, advertising, billboards, and see-through signage can be prepared using the in situ process. Patterning processes are discussed previously.

Patterning may be desired for devices where small portions of the viewing window are desired to display logos or designs, for messages to appear and disappear (for example: low battery warning), or for other display-type indicators to exist and change state (open/closed signs, walk/don't walk signs, or other such applications). Further, this patterning approach could also be used to create simple or complex dynamic displays (or pixelated displays), as well. This patterning can be easily achieved inside any of the device embodiments discussed above or below. Other potential approaches of high resolution patterning include inkjetting electrolytes onto certain areas or inkjet the conductor itself onto non-conductive surfaces, for example, inkjet PEDOT-PSS onto insulating PET substrates.

In another embodiment, patterning of individual eyes for separate color transitions can be achieved by use of multiple solutions comprising a mixture of gel electrolyte precursor and an electroactive precursor of varying chromophores.

In another embodiment, patterning can be achieved using a touch-sensitive (tactile) electrochromic switching mechanism or “electrochromic drawing.” A device incorporating this touch/switch functionality is assembled with a gap between one of the two electrodes in the sandwich and the gel electrolyte. One of the electrodes in the device is delaminated. A power supply is attached to the one remaining substrate. The gap would be bridged only when depressed, and upon contact, the gel/electrochromic complex would change color locally. This approach allows for “electrochromic drawing” or touch-displays and touch-interface electrochromics.

### Windows, Lighting, and Interior Decor

The solid-state devices described herein are particularly suited for window applications including lighting and interior decor. “Smart Windows” are those that reversibly change between a light and dark state. This is designed for privacy glass or for thermal regulation of homes and buildings. The in situ process, as described herein, is easily manufacturable to allow for large-area windows, such as these. Bus lines as described above, can be used to achieve even switching across these areas.

Lighting filters, blinds, window and lamp coverings, and other such interior design or reversibly-colored filters can include an electrochromic device prepared using the in situ process.

Additional Applications

Other applications of the electrochromic devices prepared by the in situ process include automotive, aerospace, toys, watches, jewelry, and accessories, reflective devices, solar cells, transistors, telecommunications, fabric and wearable electrochromics.

For automotive applications, auto-dimming mirrors, passenger windows, wind-shields, rear windows, rear and side-view mirrors, interior upholstery, auto-darkening sun-visor or sun-visor strips, and the like can be designed.

For aerospace applications, airplane windows, shields, passenger windows, visors, UAV coatings, camouflage, and the like can be designed.

For toy applications drawing toys, action figures and accessories, dollhouse windows and accessories, remote-control car windows or cars themselves and accessories, indicators and small displays, video games and accessories, Frisbees, and the like can be designed.

Color-changing watch faces, watch-covers or glass for modulating transparency or color, watch fobs, watch bands and accessories, wrist bands, head bands, and other jewelry, fashion, or other accessories can be designed using electrochromic devices prepared via the in situ method.

Devices such as shaving razor handles, pens or other writing implements, knick-knacks, simple display components, bag covers, or other color-changing solid (opaque) objects can be designed using electrochromic devices prepared via the in situ method.

Power sources such as organic, inorganic, and hybrid solar cells may also be assembled via the in situ method.

Various transistors, such as Field Effect Transistors (FET), Thin Film Transistors (TFTs), and organic thin-film transistors (OTFTs) can be prepared using the in situ process.

Cell phone covers, cell phone cases, tablet computer covers, tablet computer cases, laptop covers, laptop cases, GPS covers, GPS cases, and any other such devices can be prepared.

The following illustrative examples are provided to further describe the invention and are not intended to limit the scope of the claimed invention.

### EXAMPLES

### Example 1

### Goggles Prepared Via an In Situ Polymerization of EDOT Using a Gasket-Filling Process

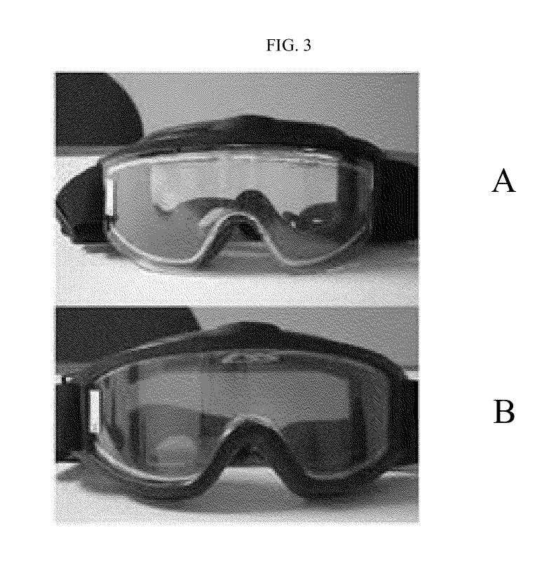

FIG. 3 and FIG. 4 are directed to electrochromic goggles prepared using a gasket-filling process. The electrochromic used in the goggles of FIG. 3 is prepared from a solution containing 250 mg of 3,4-ethylenedioxythiophene (EDOT), 1 g of lithium trifluoromethane sulfonate (LITRIF), 5 g of polyethylene glycol diacrylate (PEG-DA), 5 g of propylene carbonate (PC), 17.5 mg of dimethoxyphenylacetophenone (DMPAP), and 5 mg of glass beads (optional; prevents shorting of substrate electrodes). The lenses were made from PET-ITO substrate. The device can be triggered to function (polymerized) within 3-5 minutes by applying a continuous positive bias, and once finished, the switching time is within 30 seconds, often as low as 0.5-2 seconds. Copper tape leads were attached around all edges, for speed and ease of addressability. The device was placed in between two pieces of previously-formed ballistic polycarbonate and re-sealed with silicone rubber. Two distinct states (dark and clear) can be seen in FIG. 3. The goggle in FIG. 3 is outside of the frame that originally housed the ballistic eye pieces, however in a fully-wearable prototype, this device would be re-fitted into such a frame, which contains the power supply and control mechanisms that are currently being performed via the alligator clips and a potentiostat (CH Instruments 660A).

The device can easily be switched using a standard 3V watch battery (for example, a Duracell DL2032B) attached to a variable-transistor which modulates from −3V to +3V across a continuum.

### Example 2

### Sunglasses Prepared Via an In Situ Polymerization of EDOT

FIG. 6A is directed to a sunglasses electrochromic device prepared using the same formula materials as in Example 1. A “cookie-cutter” approach was used to allow for the selection of a desired shape of the PET-ITO substrate for a subsequent laminated-to, process. In other embodiments, the glass/plastic material of the final sunglasses itself can be used as the substrate. The device in FIG. 6 is a single device as opposed to one where each eye is a separate device for individual control.

### Example 3

### Sunglasses Prepared Via an In Situ Polymerization of Precursor Polymers

Device FIGS. 6B and 6C are directed to a sunglasses electrochromic device prepared using precursor polymer poly(bis-3,4-ethylenedioxythiophene[thiophene]-dioctyl silane). A PET-ITO substrate was spray-coated with a 20 mg/mL solution (in dichloromethane) of poly(bis-3,4-ethylenedioxythiophene[thiophene]-dioctyl silane). The precursor is insulating and yellow in color when applied. The device was assembled using a gel of 1 g of lithium trifluoromethane sulfonate (LITRIF), 5 g of polyethylene glycol diacrylate (PEG-DA), 5 g of propylene carbonate (PC), 17.5 mg of dimethoxyphenylacetophenone (DMPAP), and 5 mg of glass beads (optional; prevents shorting of substrate electrodes). The device was sealed using Norland Optics UV-curable adhesive and the gel electrolyte was cured at 365 nm for 5 minutes. The device was then subjected to a +3V bias for 60s to polymerize the precursor film. The device switches within 1-2 seconds and goes between the deep red color (neutral state) (seen in FIGS. 6B and in 6C bottom) and the light blue color (oxidized state; seen in FIG. 6C top).

### Example 4

### Red/Blue 3-D Sunglasses Prepared Via an In Situ Polymerization of Precursor Polymers

Device FIG. 6D is directed to a red/blue 3D sunglasses electrochromic device prepared using the precursor material, processing conditions, gel composition and curing conditions of Example 3. One substrate (e.g. “left eye”) was coated with precursor while the other substrate (“right eye”) was coated with the same precursor. When formed, the device was converted by first applying the potential to one substrate and then reversing the potential to convert the other side. Once the in situ polymerization was complete, the two “eyes” switched in a complimentary fashion. While one was red (neutral state), the opposite electrode and polymer was blue (oxidized state) (see FIG. 6D). Reversing the potential bias reversed the color for each “eye” of the device.

### Example 5

### Three Electrode Electrochromic Device Architecture

A three electrode assembled solid-state device was prepared similar to the general schematic of FIG. 1b. A 2.5% wt EDOT device was fabricated in a three electrode system with Ag wire as the reference electrode. The Ag electrode is 0.225 V vs. NHE. The monomers in the device were converted under 1.1 V for 40 seconds, then the device was switched in a potential window of −0.8 V to +0.8 V (pulse width=3 s) for 10 cycles. The transmittance was measured at 595 nm, which is the 2,max of PEDOT. For the Colored state, the transmittance value is 31%, and for the Bleach state, the transmittance value is 56%. Contrast=56%-31%=25%. The switching speed for this example was defined as the time needed to attain 95% of its full transmittance value. Based on calculations from the transmittance response to device switching, 0.4 seconds switching speed was found for both Bleaching (from full color to achieve 95% bleach) and Coloring (from full bleach to attain 95% color).

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising”, “having”, “including”, and “containing” are to be construed as open-ended terms (i.e., meaning “including, but not limited to”) unless otherwise noted. “Or” means and/or. Recitation of ranges of values herein are merely intended to serve as a shorthand method of referring individually to each separate value falling within the range, unless otherwise indicated herein, and each separate value is incorporated into the specification as if it were individually recited herein. All ranges disclosed herein are inclusive and combinable. The modifier “about” used in connection with a quantity is inclusive of the stated value and has the meaning dictated by the context (e.g., includes the degree of error associated with measurement of the particular quantity).

The essential characteristics of the present invention are described completely in the foregoing disclosure. One skilled in the art can understand the invention and make various modifications without departing from the basic spirit of the invention, and without deviating from the scope and equivalents of the claims, which follow. Moreover, any combination of the above-described elements in all possible variations thereof is encompassed by the invention unless otherwise indicated herein or otherwise clearly contradicted by context.

What is claimed is:

1. A method of forming a solid-state device, comprising:
filling a gel electrolyte precursor and an electroactive precursor into an enclosed chamber, wherein the electroactive precursor is an electroactive monomer, a conducting oligomer, a viologen, a conducting polymer precursor, or a combination thereof;
crosslinking the gel electrolyte precursor to form a combination of a crosslinked gel electrolyte composition comprising the electroactive precursor, wherein the combination is disposed between at least two electrodes, and wherein a potential source is in electrical communication with the at least two electrodes; and
applying a voltage to polymerize the electroactive precursor to form a composite comprising conjugated polymer and crosslinked gel electrolyte composition.

2. The method of claim 1, wherein the solid-state device comprises more than one enclosed chamber.

3. The method of claim 1, wherein the enclosed chamber comprises optical panes.

4. The method of claim 1, wherein the enclosed chamber is hermetically sealed prior to applying the voltage.

5. The method of claim 1, wherein the crosslinked gel electrolyte composition comprises a lithium, sodium, or potassium salt, or an ionic liquid.

6. The method of claim 1, wherein the crosslinked gel electrolyte is formed by crosslinking a gel electrolyte precursor in the presence of the electroactive precursor to form a layer of crosslinked gel electrolyte comprising the electroactive precursor.

7. The method of claim 1, wherein a layer of a second electrolyte composition is disposed between an electrode and the combination of the crosslinked gel electrolyte composition and electroactive precursor, wherein the layer of second electrolyte composition optionally further comprises a second electroactive precursor.

8. The method of claim 7, wherein the applying voltage polymerizes the electroactive precursor, and the method further comprises applying a second voltage to polymerize the second electroactive precursor.

9. The method of claim 1, wherein the device further comprises a reference electrode.

10. The method of claim 1, wherein the electroactive precursor is thiophene, substituted thiophene, carbazole, 3,4-ethylenedioxythiophene, thieno[3,4-b]thiophene, substituted thieno[3,4-b]thiophene, dithieno[3,4-b:3′,4′-d]thiophene, thieno[3,4-b]furan, substituted thieno[3,4-b]furan, bithiophene, substituted bithiophene, pyrrole, substituted pyrrole, acetylene, phenylene, substituted phenylene, naphthalene, substituted naphthalene, biphenyl and terphenyl and their substituted versions, phenylene vinylene (e.g., p-phenylene vinylene), substituted phenylene vinylene, aniline, substituted aniline, indole, substituted indole, or a combination thereof.

11. The method of claim 1, wherein the electroactive precursor is 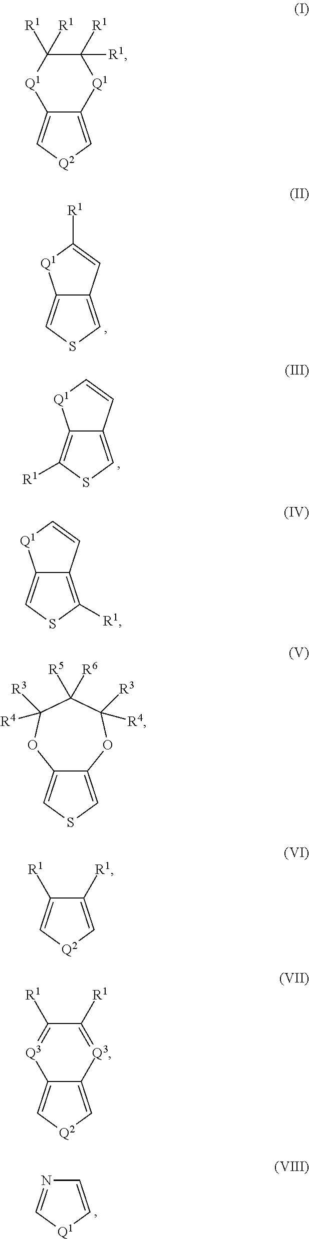 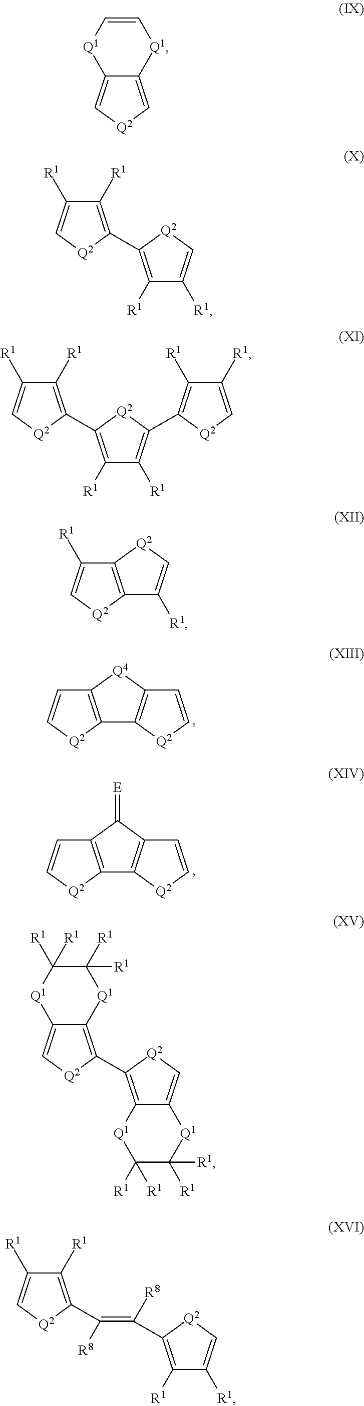 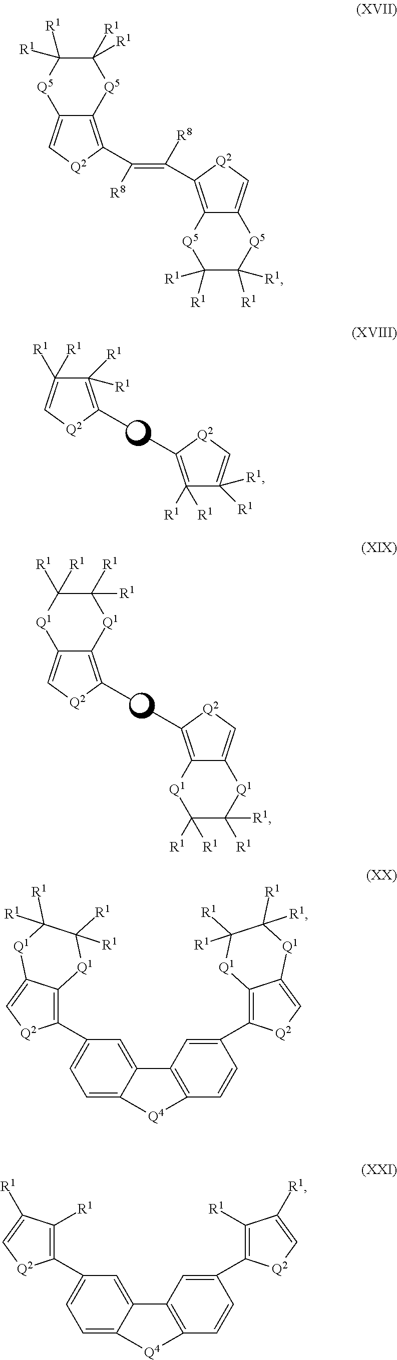 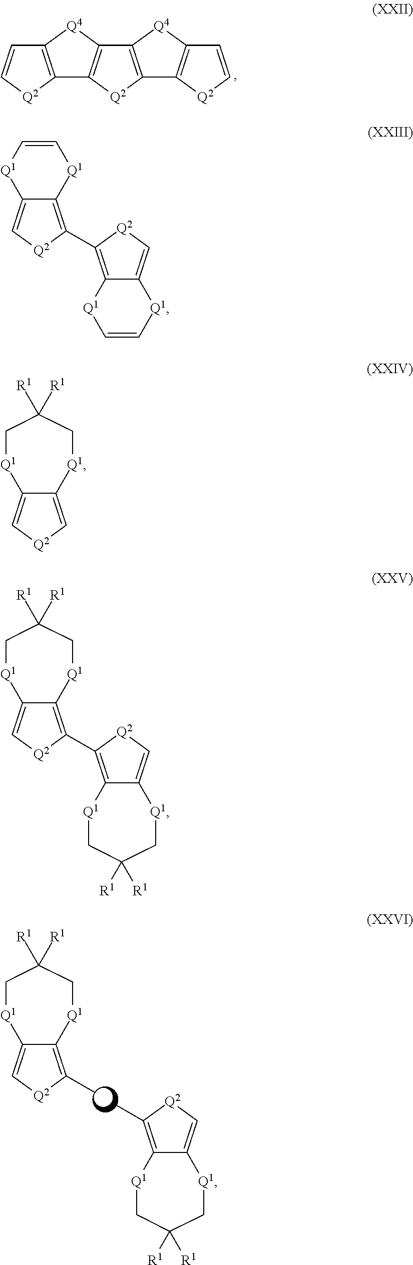 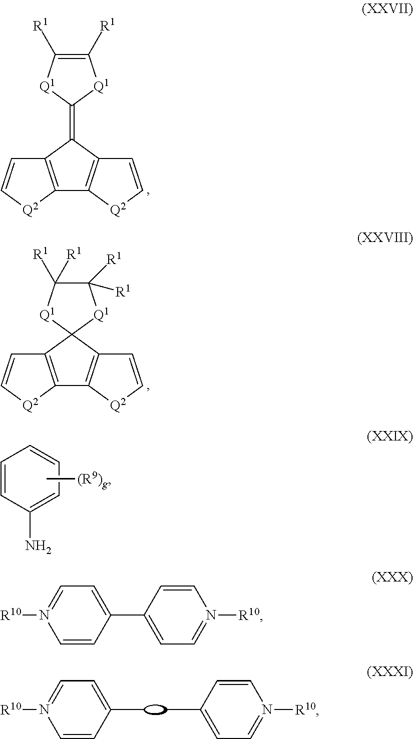
or a combination thereof,
wherein
each occurrence of Q¹ is independently S, O, or Se;
Q² is S, O, or N—R²;
each occurrence of Q³ is independently CH or N;
Q⁴ is C(R¹)₂, S, O, or N—R²;
each occurrence of Q⁵ is independently CH₂, S, or O;
each occurrence of R¹ is independently hydrogen, C₁-C₁₂ alkyl, C₁-C₁₂ alkyl-OH, C₁-C₁₂ haloalkyl, C₁-C₁₂ alkoxy, C₁-C₁₂ haloalkoxy, aryl, —C₁-C₆ alkyl-O—C₁-C₆ alkyl, or —C₁-C₆ alkyl-O-aryl;
R² is hydrogen or C₁-C₆ alkyl;
each occurrence of R³, R⁴, R⁵, and R⁶ independently is hydrogen; optionally substituted C₁-C₂₀ alkyl, C₁-C₂₀ haloalkyl, aryl, C₁-C₂₀ alkoxy, C₁-C₂₀ haloalkoxy, aryloxy, —C₁-C₁₀ alkyl-O—C₁-C₁₀ alkyl, —C₁-C₁₀ alkyl-O-aryl, —C₁-C₁₀ alkyl-aryl; or hydroxyl;
each occurrence of R⁷ is an electron withdrawing group;
each occurrence of R⁸ is independently hydrogen, C₁-C₆ alkyl, or cyano;
each occurrence of R⁹ is independently C₁-C₁₂ alkyl, C₁-C₁₂ haloalkyl, C₁-C₁₂ alkoxy, C₁-C₁₂ haloalkoxy, aryl, —C₁-C₆ alkyl-O—C₁-C₆ alkyl, —C₁-C₆ alkyl-O-aryl, or N—R²;
each occurrence of R¹⁹ is independently C₁-C₁₂ alkyl, C₁-C₁₂ haloalkyl, aryl, —C₁-C₆ alkyl-O—C₁-C₆ alkyl, or —C₁-C₆ alkyl-O-aryl;
E is O or C(R⁷)₂; 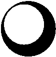
represents an aryl; 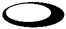
is C₂, C₄, or C₆ alkenylene, an aryl or heteroaryl; and
g is 0, 1, 2, or 3.

12. A method of forming a solid-state device, comprising
filling a gel electrolyte precursor, a first electroactive precursor, and a second electroactive precursor into an enclosed chamber,
wherein the first and second electroactive precursor are independently an electroactive monomer, a conducting oligomer, a viologen, a conducting polymer precursor, or a combination thereof, and
wherein the first electroactive precursor has a lower polymerization potential than the second electroactive precursor;
crosslinking the gel electrolyte precursor to form a combination of a crosslinked gel electrolyte composition comprising the first and second electroactive precursor, wherein the combination is disposed between at least two electrodes, and wherein a potential source is in electrical communication with the at least two electrodes; and
applying a first voltage for a period of time (t1) to polymerize the first electroactive precursor to form a composite comprising a first conjugated polymer and crosslinked gel electrolyte composition and
subsequently applying a second voltage higher than the first voltage for a period of time (t2) to polymerize the second electroactive precursor to form a composite comprising second conjugated polymer and crosslinked gel electrolyte composition.

13. A solid-state device prepared according to the method of claim 1 or 12.

14. The device of claim 13, selected from the group consisting of eyewear; windows, displays, and mirrors for electronic applications; windows, displays, and mirrors for automotive applications; windows and displays for aerospace applications; windows, displays and accessories for toys and video games; color-changing watches, jewelry, and accessories; organic, inorganic, and hybrid solar cells; and transistors.

15. The device of claim 13, wherein the device is absorptive/transmissive, absorptive/reflective, or comprises both absorptive/transmissive and absorptive/reflective components.

16. The device of claim 13, wherein the device is patterned.

17. The device of claim 13, wherein the device comprises bus lines.

18. An electrochromic eyewear device, comprising:
at least two electrodes; and
a composite disposed between the at least two electrodes, the composite comprising a conjugated polymer and a crosslinked gel electrolyte composition;
wherein the composite is formed by in situ polymerization of an electroactive precursor in a combination comprising the crosslinked gel electrolyte composition and an electroactive precursor,
wherein the electroactive precursor is an electroactive monomer, a conducting oligomer, a viologen, a conducting polymer precursor, or a combination thereof; and
wherein the conjugated polymer is not formed as a discrete film.

19. The device of claim 13, further comprising a layer disposed on the composite, the layer comprising
a second electrolyte composition, or
a second composite comprising the second electrolyte composition and a second conjugated polymer formed by in situ polymerization of a second electroactive precursor in a second combination comprising the second electrolyte composition and second electroactive precursor.

20. The device of claim 18, wherein the electroactive precursor is thiophene, substituted thiophene, carbazole, 3,4-ethylenedioxythiophene, thieno[3,4-b]thiophene, substituted thieno[3,4-b]thiophene, dithieno[3,4-b:3′,4′-d]thiophene, thieno[3,4-b]furan, substituted thieno[3,4-b]furan, bithiophene, substituted bithiophene, pyrrole, substituted pyrrole, acetylene, phenylene, substituted phenylene, naphthalene, substituted naphthalene, biphenyl and terphenyl and their substituted versions, phenylene vinylene (e.g., p-phenylene vinylene), substituted phenylene vinylene, aniline, substituted aniline, indole, substituted indole, or a combination thereof.

21. The device of claim 18, wherein the electroactive precursor is 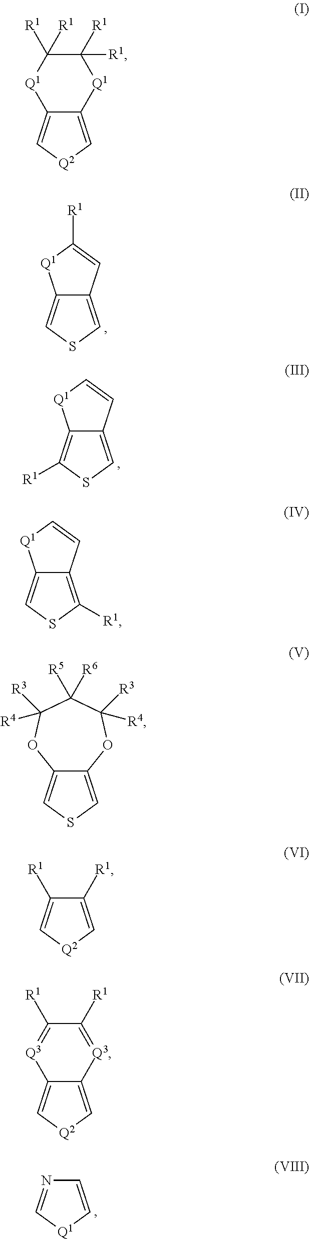 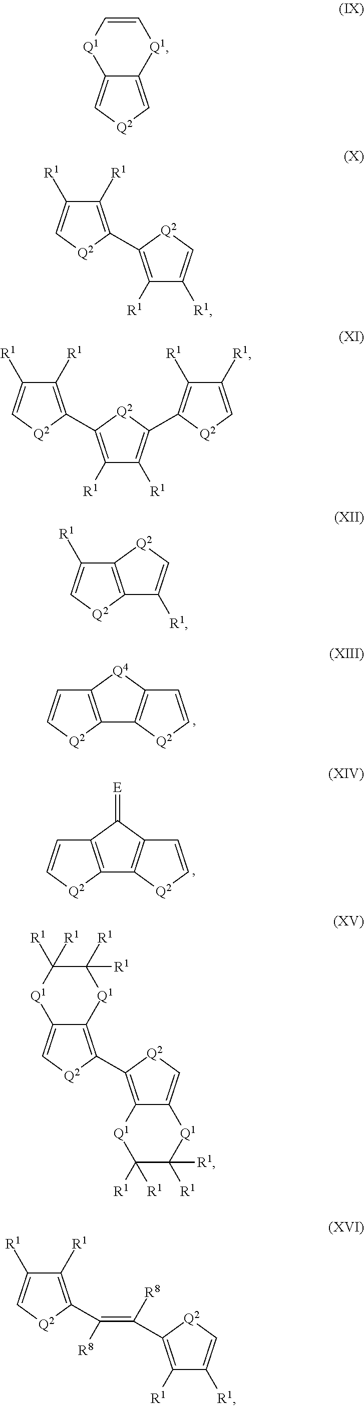 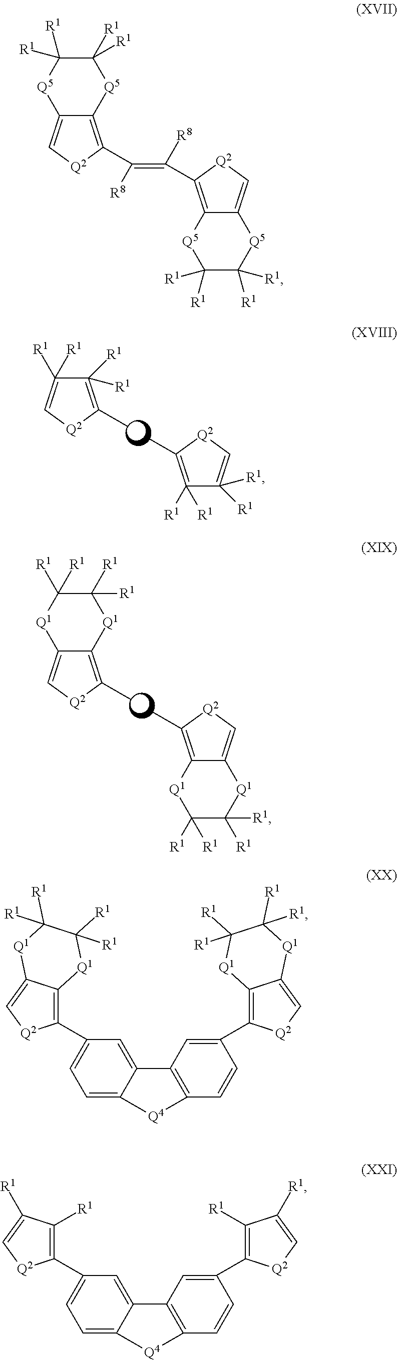 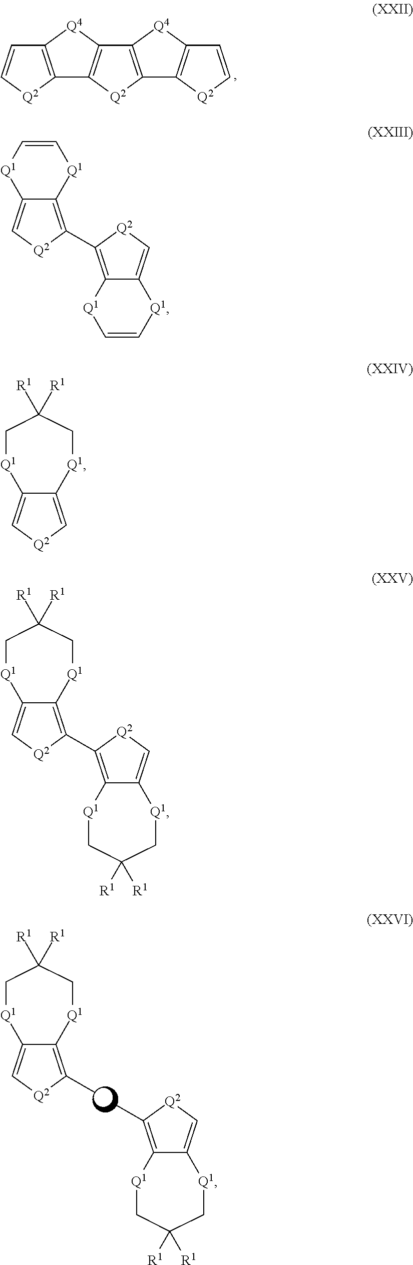 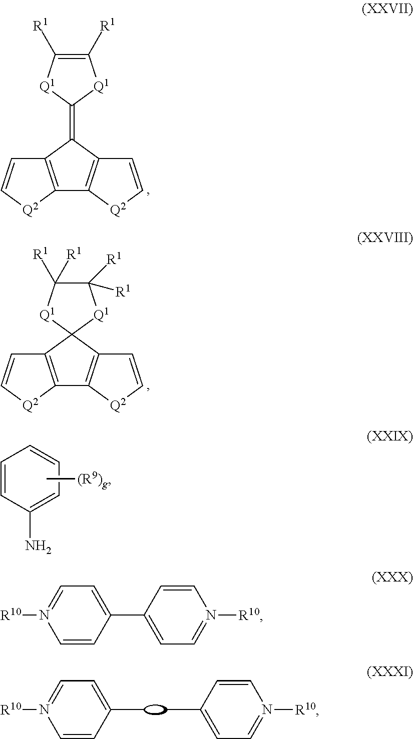
or a combination thereof,
wherein
each occurrence of Q¹ is independently S, O, or Se;
Q² is S, O, or N—R²;
each occurrence of Q³ is independently CH or N;
Q⁴ is C(R¹)₂, S, O, or N—R²;
each occurrence of Q⁵ is independently CH₂, S, or O;
each occurrence of R¹ is independently hydrogen, C₁-C₁₂ alkyl, C₁-C₁₂ alkyl-OH, C₁-C₁₂ haloalkyl, C₁-C₁₂ alkoxy, C₁-C₁₂ haloalkoxy, aryl, —C₁-C₆ alkyl-O—C₁-C₆ alkyl, or —C₁-C₆ alkyl-O-aryl;
R² is hydrogen or C₁-C₆ alkyl;
each occurrence of R³, R⁴, R⁵, and R⁶ independently is hydrogen; optionally substituted C₂₀ alkyl, C₁-C₂₀ haloalkyl, aryl, C₁-C₂₀ alkoxy, C₁-C₂₀ haloalkoxy, aryloxy, —C₁-C₁₀ alkyl-O—C₁-C₁₀ alkyl, —C₁-C₁₀ alkyl-O-aryl, —C₁-C₁₀ alkyl-aryl; or hydroxyl;
each occurrence of R⁷ is an electron withdrawing group;
each occurrence of R⁸ is independently hydrogen, C₁-C₆ alkyl, or cyano;
each occurrence of R⁹ is independently C₁-C₁₂ alkyl, C₁-C₁₂ haloalkyl, C₁-C₁₂ alkoxy, C₁-C₁₂ haloalkoxy, aryl, —C₁-C₆ alkyl-O—C₁-C₆ alkyl, —C₁-C₆ alkyl-O-aryl, or N—R²;
each occurrence of R¹⁹ is independently C₁-C₁₂ alkyl, C₁-C₁₂ haloalkyl, aryl, —C₁-C₆ alkyl-O—C₁-C₆ alkyl, or —C₁-C₆ alkyl-O-aryl;
E is O or C(R⁷)₂; 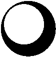
represents an aryl; 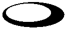
is C₂, C₄, or C₆ alkenylene, an aryl or heteroaryl; and
g is 0, 1, 2, or 3.

22. The device of claim 18, further comprising a reference electrode.

23. The device of claim 18, further comprising a potential source in electrical communication with the at least two electrodes.

24. The device of claim 18, further comprising
at least two lenses wherein each lens individually comprises
a substrate;
a conductor material disposed on the substrate to form one of the at least two electrodes; and
optionally one or more additional coatings, wherein the additional coating is a hard coat, an anti-fog coat, an anti-reflective coat, an anti-scratch coat, or a polarizing coating.

25. The device of claim 24, wherein the substrate is ballistic, polarized, or a combination thereof.

26. The device of claim 18, wherein the eyewear device is double, triple, or n-paned.

27. The device of claim 18, further comprising a switching control element in electrical communication with the at least two electrodes to allow for the color switching of the conjugated polymer.

28. The device of claim 18, further comprising a filtering dye, nanoparticles, or a photochromic dye to modulate the electrochromic coloration, or for spectral darkening;
wherein the filtering dye, nanoparticles, or a photochromic dye is present in the composite, in the at least two electrodes, or is in a discrete film or coating separate from the composite.

29. The device of claim 18, further comprising bus lines in electrical communication with the at least two electrodes.

30. The device of claim 18, further comprising a fail-safe device and fail-safe potential source to switch the device to a fail-safe mode.

31. The device of claim 30, wherein the fail-safe device is triggered by light, temperature, pressure, or a combination thereof.

32. The device of claim 30, wherein the fail-safe device upon sensing a failure trigger, applies a voltage to the at least two electrodes to switch the conjugated polymer to its oxidized or reduced state.

33. The device of claim 30, wherein the fail-safe mode is fail-to-clear or fail-to-dark.
